(19) United States
(12) Patent Application Publication
(10) Pub. No.: US 2023/0153389 A1
(43) Pub. Date: May 18, 2023

(54) SYSTEMS AND METHODS FOR AUTOMATICALLY IDENTIFYING, ANALYZING AND REDUCING EXTRANEOUS WAVEFORM CAPTURES

(71) Applicant: Schneider Electric USA, Inc., Andover, MA (US)

(72) Inventors: Jon A. Bickel, Murfreesboro, TN (US); Johannes Menzel, Eybens (FR)

(73) Assignee: Schneider Electric USA, Inc., Boston, MA (US)

(21) Appl. No.: 17/985,506

(22) Filed: Nov. 11, 2022

Related U.S. Application Data
(60) Provisional application No. 63/278,679, filed on Nov. 12, 2021.

(51) Int. Cl. G06K 9/00

(52) U.S. Cl. CPC G06K 9/0053; G06K 9/00503

(57) ABSTRACT

A method for automatically identifying, analyzing and reducing extraneous waveform captures (WFCs) includes capturing at least one energy-related waveform in an electrical system using at least one waveform capture device. The at least one captured energy-related waveform is analyzed to determine whether the at least one captured energy-related waveform meets the criteria of being considered an extraneous WFC, a partially extraneous WFC, a redundant WFC, or a provisional WFC. In accordance with some embodiments of this disclosure, one or more actions are performed in response to determining the at least one captured energy-related waveform meets the criteria of being considered an extraneous WFC, a partially extraneous WFC, a redundant WFC, or a provisional WFC.

### CROSS-REFERENCE TO RELATED APPLICATION

This application claims the benefit of and priority to U.S. Provisional Application No. 63/278,679, filed on Nov. 12, 2021, which application was filed under 35 U.S.C. §119(e) and is incorporated by reference herein in its entirety.

### FIELD

This disclosure relates generally to electrical energy/power system(s) (herein referred to as electrical system(s)), and more particularly, to systems and methods for automatically identifying, analyzing and reducing extraneous waveform captures (WFCs) associated with electrical system(s).

### BACKGROUND

As is known, various types of devices (e.g., metering devices, breakers, relays, etc.) may be used to generate WFCs, and/or to collect data that may be used to generate WFCs, in an electrical system. The WFCs may be measurements and recordings of voltage and/or current signal data (and/or any waveform or high-speed time series data derived from voltage and/or current signals). The WFCs can be initiated/triggered using many methods including, for example, manually, automatically (e.g., after exceeding one or more parameter threshold(s)), periodically (e.g., at 12:00pm daily), in response to an external input (e.g., change in digital status input signal), arbitrarily, or by some other cause or means. The WFCs may also include other internal/external information such as time stamps, sample rates, nominal voltages, load information, event information, status input changes, data from other devices, equipment and/or systems. A device capturing waveform information from six channels with a length of ten cycles and a sample rate of one thousand and twenty-four samples/cycle/channel, for example, may result in a file size of approximately one hundred twenty kilobytes (KB). During the normal operation of an electrical power monitoring system (EPMS) over time, for example, many WFCs will be obtained from multiple channels and multiple devices, potentially generating gigabytes to terabytes of data to be stored, maintained, retrieved, analyzed, and so forth. As is known, data storage may be expensive and having too much data can slow down processing, analysis, troubleshooting, etc. of the data collected and stored.

### SUMMARY

The disclosed invention provides several uses and benefits for end-users. One example use of this invention is to automatically analyze electrical waveform data (i.e., waveform captures or WFCs) to identify and reduce extraneous WFCs generated/acquired from Electrical Power Monitoring Systems (EPMSs), or any related component/element (e.g., Intelligent Electronic Devices (IEDs)). Reducing extraneous WFCs may be performed directly, for example, by deleting an identified extraneous WFC in one or more elements of an EPMS. Alternatively, reducing extraneous WFCs may be performed indirectly, for example, by tagging a WFC as extraneous and then applying a filter on all WFCs tagged as extraneous WFCs to limit or constrain subsequent analyses of the WFCs. Another example of reducing costs associated with extraneous WFCs is to move all WFCs tagged as extraneous WFCs into a cloud cold storage, which reduces the cost of storage. Data in cloud cold storage may not be available for analysis unless specifically requested by an end-user. Another indirect method to reduce the propagation of extraneous WFCs is by regulating conveyance of a tagged WFC between any first EPMS element and any second EPMS element. Direct and/or indirect reduction of extraneous WFCs may inherently reduce memory requirements, superfluous analyses, comms bandwidth, and/or processing requirements of WFCs in EPMSs.

An extraneous WFC is defined herein as a WFC that has been analyzed and found to provide no or minimal useful information and/or provide no or minimal additional/superfluous information or value for operators of EPMSs. Extraneous WFCs are often waveform signature data generated after an event has reached its conclusion, and are generally uninteresting to an end-user/operator, not beneficial for analysis, and/or provide limited useful information. Because many EPMS end-users and/or operators may not be adequately skilled in the analyzing WFCs, they may inadvertently assume important information exists where none is available.

Extraneous WFCs may be intentionally or inadvertently generated as a repercussion of legitimate/useful WFCs, misconfiguration (e.g., excessively constrained WFC thresholds), as a typical outcome from specific IED types, random or scheduled captures, and/or resulting from/due to other reasons. Extraneous WFCs are generally not useful, prone to generate confusion (e.g., ‘Why was it captured in the first place?’), and create ambiguous “noise,” clutter, and/or bias in the analysis of electrical events.

A redundant WFC, which is another example type of WFC in accordance with embodiments of this disclosure, can originate either from a legitimate/real event or from spurious causes. A redundant WFC occurs more than once and exhibits one or more common/similar characteristics or traits. A redundant WFC may or may not be useful for troubleshooting purposes. In accordance with some embodiments of this disclosure, an example purposes of identifying redundant WFCs is to quantify their existence, to evaluate the amount of memory used to store them, and to determine the potential reduction in a system’s memory requirements by eliminating some or all of them.

A provisional WFC, which is a further example type of WFC in accordance with embodiments of this disclosure, is defined herein as a category of WFC that has been analyzed; however, it may or may not present any clear value (i.e., its value is found to be indeterminate). The term “provisional” indicates insufficient information exists to establish a WFC’s value to the end-user/operator at the time of the analysis. The WFC may be tagged accordingly to allow subsequent analysis at a future time to identify said WFC as valid or as extraneous. Examples of provisional WFCs are ones that have been automatically indicated as a “borderline” extraneous WFC, manually indicated as a provisional WFC, or have not been analyzed to determine whether it is extraneous.

Provisional WFCs are WFCs that cannot be tagged positively as an extraneous WFC nor positively as a non-extraneous WFC (i.e., contains relevant information for a real event), so are waveforms where further analysis is required to confirm the classification as an extraneous or non-extraneous or redundant WFC. One example value of provisional WFCs is that it can allow a system, end-user/operator, and/or algorithm to categorize and store a WFC into a secondary priority group for subsequent analysis(s), use in troubleshooting (as needed), and/or to quantify “unknown” and uncategorized WFCs collected by the EPMS and its elements. A second value of provisional WFCs is to allow end-users/operators to filter and/or categorize the WFCs during analysis and provide more attention to distinctive and/or significant WFCs, thus reducing the end-user/operator’s burden.

A simple example may be the algorithm analyzing one or more WFCs from an EPMS and finding some to be “marginally extraneous.” Because the WFC is determined to be borderline extraneous, the algorithm may tag the WFC as provisional and allow the end-user/operator at analyze it discretely and discretionally at a future time.

A second example may be an electrical system experiencing a voltage event that was captured by many IEDs located on the same electrical bus. The voltage WFCs should be nearly identical; however, the current WFCs will likely be dissimilar (i.e., due to unique downstream loads). The voltage WFCs may be tagged as extraneous and the current WFCs may be tagged as non-extraneous. It would be possible to retain a single voltage WFC (i.e., for each phase) from the voltage event and keep all current WFCs, using the single voltage WFC (i.e., for each phase) as a representative voltage signal for all WFCs from IEDs located on the same electrical bus. The end-user/operator may choose to tag the removed voltage WFCs as provisional if it is felt they may be beneficial at a future time.

In accordance with some embodiments of this disclosure, a WFC may be evaluated to determine whether it contains useful information, and those without (or with questionable) usefulness/value (e.g., extraneous, partially extraneous, or in some cases, provisional) may be subject to one or more actions, including: tagging (e.g., extraneous, redundant, provisional, etc.), filtering, categorizing, deleting, removing, recommending and/or updating settings and/or configurations, lowering/reducing or elevating the priority (e.g., lower priority for analysis, processing, transmitting, etc.), compressing, moving and/or redistributing (e.g., cloud cold storage to reduce storage costs), logging into a “provisional WFC” list for later evaluation by an end-user/operator and/or expert, and so forth.

In accordance with some embodiments of this disclosure, the above and below discussed WFCs may be generated using one or more WFC devices (e.g., IEDs). The WFC device(s) may be positioned or located, for example, at one or more locations or points (e.g., metering points) in an electrical system. The electrical systems may be associated with at least one load, process, building, facility, watercraft, aircraft, or other type of structure, for example.

As will be further appreciated from discussions below, systems and methods for automatically identifying, analyzing and reducing extraneous WFCs are provided herein. In one aspect of this disclosure, a method for automatically identifying, analyzing and reducing extraneous WFCs includes capturing at least one energy-related waveform in an electrical system using at least one WFC device, and analyzing the at least one captured energy-related waveform to determine whether the at least one captured energy-related waveform meets the criteria of being considered an extraneous WFC, a partially extraneous WFC, a redundant WFC, or a provisional WFC. For example, in embodiments in which the at least one captured energy-related waveform includes a plurality of WFCs, it is possible that one or more WFCs of the at least one captured energy-related waveform may be considered an extraneous WFC, and one or more WFCs of the at least one captured energy-related waveform may not be considered an extraneous WFC (i.e., the at least one captured energy-related waveform may include at least one extraneous WFC).

In accordance with some embodiments of this disclosure, one or more actions may be performed in response to determining the at least one captured energy-related waveform meets the criteria of being considered an extraneous WFC, a partially extraneous WFC, a redundant WFC, or a provisional WFC. These actions may include, for example, at least one of: deleting or otherwise removing the at least one captured energy-related waveform, tagging or otherwise indicating the defined status of the at least one captured energy-related waveform, storing the at least one captured energy-related waveform in specific location(s), recommending and/or updating waveform capture setting(s) and/or configuration(s) in the at least one waveform capture device capturing the at least one captured energy-related waveform, lowering and/or reducing the priority and/or importance of the at least one captured energy-related waveform, compressing the at least one captured energy-related waveform, and reducing the at least one captured energy-related waveform by one or more cycles to minimize its memory requirements.

In accordance with some embodiments of this disclosure, one or more additional actions may be taken subsequent to and/or in parallel to performing the at least one of the actions in response to determining the at least one captured energy-related waveform meets the criteria of being considered an extraneous WFC or includes at least one extraneous WFC. For example, associated alarm data may be extracted, data may be used for other purposes such as a sample of the system’s post-event response, other settings may be changed in association with alarm settings for more useful alarms and better alarm prioritization, and/or information may be used to enhance segment-related analytics in cloud-based applications, etc. It is understood that other data originating in the at least one waveform capture device (or elsewhere in an EPMS) may optionally be considered as extraneous along with the associated WFC. Examples of the other data may include, for example, data associated with the WFC from an event (or a related event).

In accordance with some embodiments of this disclosure, one technique that may be used to determine whether the at least one captured energy-related waveform meets the criteria of being considered an extraneous WFC, a partially extraneous WFC, a redundant WFC, or a provisional WFC, is performing a point-by-point comparison between: at least one data point in at least one first cycle of the at least one captured energy-related waveform, and at least one or more corresponding data points in at least one second cycle of the at least one captured energy-related waveform and/or other WFCs, to determine whether the at least one captured energy-related waveform meets the criteria of being considered an extraneous WFC, a partially extraneous WFC, a redundant WFC, or a provisional WFC. In accordance with some embodiments of this disclosure, at least one of: the at least one data point in the at least one first cycle of the at least one captured energy-related waveform, and the at least one or more corresponding data points in the at least one second cycle of the at least one captured energy-related waveform and/or other WFCs, is at least one of empirically determined and derived by interpolating to ensure the data points are correctly positioned based on their occurrence within the at least one captured energy-related waveform.

In accordance with some embodiments of this disclosure, sensitivity of the algorithm used to perform the point-by-point comparison can be configured and/or determined based on at least one of: the data points and/or cycles being compared, timestamps of the datapoints being compared, the number of data points and/or cycles used in the comparison, comparison tolerance of the date points and/or cycle phase angles, comparison tolerance of the data point and/or cycle magnitude, number of consecutive data points being compared, and specific phases being compared.

In accordance with some embodiments of this disclosure, in response to determining the at least one captured energy-related waveform meets the criteria of being considered a partially extraneous WFC, the at least one captured energy-related waveform may be reduced by one or more data points to simplify future analysis of the at least one captured energy-related waveform and/or for minimizing memory requirements for storing the at least one captured energy-related waveform. In some instances, it is possible that the entire WFC may ultimately be eliminated (e.g., deleted or removed) if it is considered to be completely extraneous or redundant.

It is understood that other exemplary techniques may be used to determine whether the at least one captured energy-related waveform meets the criteria of being considered an extraneous WFC, a partially extraneous WFC, a redundant WFC, a provisional WFC, or an original WFC. For example, the at least one captured energy-related waveform may be compared to at least one other WFC using one or more other data analysis techniques to make the determination (i.e., using data analysis techniques other than a point-by-point comparison). In some exemplary implementations, the at least one other WFC is or includes at least one WFC and/or at least one model of a WFC from a supplemental resource (e.g., a WFC library or repository). In this example, the WFC library or repository may be a cloud-based WFC library or repository in some instances. In accordance with some embodiments of this disclosure, the one or more other data analysis techniques used to perform the comparison may leverage other existing algorithmic calculations such as for example expert-based algorithms, rules-based algorithms, statistics-based algorithms, visual comparison(s), curve fitting algorithms, signal processing algorithms, similarity and dissimilarity distance calculations, clustering, spike and peak identifications, modeling & anomaly detection, statistics, time-series analysis, time-series clustering, bandwidth models per type of event, matching waveshape similarity scores within the time domain, matching waveshape similarity scores allowing for changes in the time domain (e.g., using algorithms such as “Dynamic Time Warping,” which is well documented), and/or semi-supervised learning and supervised learning techniques and algorithms when some classification can be leveraged or user defined (e.g., deep learning, neural networks, etc.). In accordance with some embodiments of this disclosure, one or more other data analysis techniques may be used to transform the data before performing the WFC comparison. This approach may leverage or require algorithmic pre-processing calculations, for example, time domain transformations and spectral/spectrum analysis(es), signal processing feature extraction algorithms, and/or wavelet transform.

In accordance with some embodiments of this disclosure, it may be determined whether each WFC of the at least one captured waveform to be analyzed was captured using same or similar WFC characteristics (i.e., whether each WFC is/was configured to be captured using same or similar WFC characteristics). The WFC characteristics may include, for example, at least one of: sample rate, resampling algorithms, downsampling algorithms, and other waveform capture constraints (e.g., Current Transformer (CT) & Power Transformer (PT) characteristics, etc., which may impact the measurements due to different constraints and/or sensitivities). In response to determining each WFC of the at least one captured waveform to be analyzed was not captured using same or similar WFC characteristics, it may be determined whether one or more of the WFCs need to be reconstructed to make the WFCs suitable for comparisons and/or other meaningful analysis. In response to determining one or more of the WFCs need to be reconstructed to make the WFCs suitable for comparisons and/or other meaningful analysis, the one or more of the WFCs may be reconstructed based on or using one or more techniques. The one or more techniques may include, for example, at least one of: resampling, upsampling, downsampling, decimating, normalizing, adding a range of acceptability, and so forth. In some implementations, more advanced data science techniques, algorithms or preprocessing tools/techniques/steps may be leveraged such as, for example, wavelet transform based algorithms, or time domain transformations (e.g., FTT analysis).

In accordance with some embodiments of this disclosure, the criteria of being considered an extraneous WFC or partially extraneous WFC is/are based on at least one of: load type(s), load mix, process(es), application(s), customer type(s)/segment(s), memory requirements, and cost(s), etc. It therefore follows that a WFC considered to be extraneous for one load type, load mix, process, application, customer type/segment, etc. may not be deemed/considered an extraneous WFC for another load type, load mix, process, application, customer type/segment, etc. in some instances. Additionally, a WFC not considered to be extraneous for one load type, load mix, process, application, customer type/segment, etc. may be considered an extraneous WFC for another load type, load mix, process, application, customer type/segment, etc. in some instances.

It is possible to evaluate WFCs from events to determine whether useful information is contained within the WFC, and take the appropriate action. These actions may include, for example: deleting/removing extraneous WFCs, tagging (e.g., metadata indicates as extraneous, partially extraneous, provisional, redundant, etc.), recommending and/or updating WFC setting(s)/configuration(s), lowering/reducing the priority (lower priority for analysis, processing, transmitting, etc.) of extraneous WFCs, compressing extraneous WFCs (e.g., automatically, perhaps indicating the reason it was compressed), and so forth.

In accordance with some embodiments of this disclosure, the disclosed invention automatically analyzes WFCs to determine whether anomalies, dissimilarities or relevant changes exist over a WFC’s duration in at least part of at least one of the WFC’s voltage(s) and current(s) signals. If so, the WFC may be determined to be containing relevant information related to an event that occurred. In this case, the WFC is non-extraneous. In contrast, if the WFC contains no anomalies, no dissimilarities and no relevant changes over a WFC’s duration in any of the WFC’s voltage(s) and current(s) signals, the WFC may be determined to be extraneous. Further analysis evaluates the extraneous WFC to determine whether it may be considered redundant. A single reoccurrence or multiple reoccurrences of the same or very similar WFC to the original WFC indicates the WFC may be redundant in accordance with embodiments of this disclosure. If the comparison/analysis of a first WFC and a second WFC is marginal, then it may be considered redundant. Alternatively, if the comparison/analysis of a first WFC and a second WFC does not provide a sufficient indication to determine if the second WFC is different from the first WFC, the second WFC may be categorized as provisional (e.g., tentative/indeterminant) until a determination can be made either by an end-user/operator, expert, algorithm, and/or some other means. Accordingly, a second WFC may be considered redundant, whether it is extraneous or related to a real event, or provisional. It is understood that the algorithm(s) for identifying these various types of WFCs can exist anywhere within the EPMS, for example, the at least one IED, Edge S/W, Gateway, Cloud-based application, PLCs, etc.

It is understood that the extraneous WFCs may be automatically analyzed, reduced and/or stored substantially anywhere, for example, including in the at least one waveform capture device used for capturing the at least one energy-related waveform. It is also understood that the at least one captured energy-related waveform can also be sent to the Edge S/W, Gateway, and/or Cloud and be evaluated/addressed there. The evaluation/addressment may also be performed on non-proprietary waveform capture(s). It is understood that in accordance with some aspects of this disclosure, the focus of the disclosed invention is on the analysis and reduction of extraneous WFCs; not so much where it occurs (e.g., for root cause analysis). In the present disclosure, it is determined which WFCs and what parts of the WFCs are extraneous, and which part of a WFC contain relevant information related to an event which occurred as well as which parts may be considered redundant, etc. It is understood that performing the analysis/evaluation, etc. disclosed herein may optimize the data stored/retained (e.g., in the Cloud, the Edge, Gateway, waveform capture devices, etc.) in some instances.

In accordance with some embodiments of this disclosure, the above method (and the other methods and systems discussed below) may be implemented on one or more waveform capture devices (e.g., IEDs), for example, on the at least one waveform capture device that may be used to capture the at least one energy-related waveform. Additionally, in some embodiments the above method (and the other methods and systems discussed below) may be implemented partially or fully remote from the at least one waveform capture device, for example, in a gateway, a cloud-based system, within Edge S/W software (which may alternatively be referred to as a “head-end” or “Edge” system herein), a remote server, etc.. Examples of the at least one waveform capture device may include a smart utility meter, a power quality meter, and/or another measurement and/or protection device (or devices) capable of capturing WFCs. The at least one waveform capture device may include breakers, relays, power quality correction devices, uninterruptible power supplies (UPSs), filters, and/or variable speed drives (VSDs), for example. Additionally, the at least one waveform capture device may include at least one virtual meter in some embodiments.

It is understood that the at least one energy-related WFC described in connection with the above method (and the other methods and systems discussed below) may be associated with energy-related signals captured or measured by the at least one waveform capture device. For example, in accordance with some embodiments of this disclosure, the at least one energy-related WFC may be generated from at least one energy-related signal captured or measured by the at least one waveform capture device. According to IEEE Standard 1057-2017, for example, a waveform is “[a] manifestation or representation (e.g., graph, plot, oscilloscope presentation, discrete time-series, equations, table of coordinates, or statistical data) or a visualization of a signal.” With this definition in mind, the at least one energy-related waveform may correspond to a manifestation or representation or a visualization of the at least one energy-related signal. It is understood that the above relationship is based on one standards body’s (e.g., IEEE in this case) definition of a waveform, and other relationships between a waveform and a signal are of course possible, as will be understood by one of ordinary skill in the art.

It is understood that the energy-related signals or waveforms captured or measured by the at least one waveform capture device discussed above may include, for example, at least one of: a voltage signal, a current signal, input/output (I/O) data, and a derived or extracted value. In some embodiments, the I/O data includes at least one of a digital signal (e.g., two discrete states) and an analog signal (e.g., continuous variable). The digital signal may include, for example, at least one of on/off status(es), open/closed status(es), high/low status(es), synchronizing pulse and any other representative bi-stable signal. Additionally, the analog signal may include, for example, at least one of temperature, pressure, volume, spatial, rate, humidity, and any other physically or user/usage representative signal.

In accordance with some embodiments of this disclosure, the derived or extracted value includes at least one of a calculated, computed, estimated, derived, developed, interpolated, extrapolated, evaluated, and otherwise determined additional energy-related value from at least one of the measured voltage signal and/or the measured current signal. In some embodiments, the derived value additionally or alternatively includes at least one of active power(s), apparent power(s), reactive power(s), energy(ies), harmonic distortion(s), power factor(s), magnitude/direction of harmonic power(s), harmonic voltage(s), harmonic current(s), interharmonic current(s), interharmonic voltage(s), magnitude/direction of interharmonic power(s), magnitude/direction of sub-harmonic power(s), individual phase current(s), phase angle(s), impedance(s), sequence component(s), total voltage harmonic distortion(s), total current harmonic distortion(s), three-phase current(s), phase voltage(s), line voltage(s), spectral analysis and/or other similar/related parameters. In some embodiments, the derived value additionally or alternatively includes at least one energy-related characteristic, the energy-related characteristic including magnitude, direction, phase angle, percentage, ratio, level, duration, associated frequency components, energy-related parameter shape, decay rate, and/or growth rate. In accordance with some embodiments of this disclosure, the derived or extracted value may be linked to at least one customer type, process, load(s) identification, etc., for example.

It is understood that the energy-related signals or waveforms captured or measured by the at least one waveform capture device may include (or leverage) substantially any electrical parameter derived from at least one of the voltage and current signals (including the voltages, currents, and frequencies themselves), for example. It is also understood that the energy-related signals or waveforms may be continuously or semi-continuously/periodically captured/recorded and/or transmitted and/or logged by the at least one waveform capture device. As noted above, the at least one captured energy-related waveform may be analyzed (e.g., in real-time, pseudo-real time, or historically) to determine if the at least one captured energy-related waveform meets the criteria of being considered an extraneous WFC, a partially extraneous WFC, a redundant WFC, or a provisional WFC.

A system for automatically identifying, analyzing and reducing extraneous WFCs is also provided herein. In one aspect of this disclosure, the system includes at least one processor and at least one memory device coupled to the at least one processor. The at least one processor and the at least one memory device may be configured to capture at least one energy-related waveform in an electrical system using at least one waveform capture device and analyze the at least one captured energy-related waveform to determine whether the at least one captured energy-related waveform meets the criteria of being considered an extraneous WFC, a partially extraneous WFC, a redundant WFC, or a provisional WFC. In accordance with some embodiments of this disclosure, one or more actions may be performed in response to determining the at least one captured energy-related waveform meets the criteria of being considered an extraneous WFC, a partially extraneous WFC, a redundant WFC, or a provisional WFC. As previously noted in connection with above-discussed method, the one or more actions may include, for example, at least one of: deleting or otherwise removing the at least one captured energy-related waveform, tagging or otherwise indicating the defined status of the at least one captured energy-related waveform, storing the at least one captured energy-related waveform in specific location(s), recommending and/or updating waveform capture setting(s) and/or configuration(s) in the at least one waveform capture device capturing the at least one captured energy-related waveform, lowering and/or reducing the priority and/or importance of the at least one captured energy-related waveform, and compressing the at least one captured energy-related waveform.

In some embodiments, the at least one waveform capture device capturing the energy-related waveforms includes at least one IED. Additionally, in some embodiments the at least one waveform capture device (e.g., IED) includes at least one metering device. The at least one metering device may correspond, for example, to at least one metering device in the electrical system for which the energy-related waveforms are being captured/monitored.

As used herein, an IED is a computational electronic device optimized to perform one or more functions. Examples of IEDs may include smart utility meters, power quality meters, microprocessor relays, digital fault recorders, and other metering devices. IEDs may also be imbedded in variable speed drives (VSDs), uninterruptible power supplies (UPSs), circuit breakers, relays, transformers, or any other electrical apparatus. IEDs may be used to perform measurement/monitoring and control functions in a wide variety of installations. The installations may include utility systems, industrial facilities, warehouses, office buildings or other commercial complexes, campus facilities, computing co-location centers, data centers, power distribution networks, or any other structure, process or load that uses electrical energy. For example, where the IED is an electrical power monitoring device, it may be coupled to (or be installed in) an electrical power transmission or distribution system and configured to sense/measure and store data (e.g., waveform data, logged data, I/O data, etc.) as electrical parameters representing operating characteristics (e.g., voltage, current, waveform distortion, power, etc.) of the electrical distribution system. These parameters and characteristics may be analyzed by a user to evaluate potential performance, reliability and/or power quality-related issues, for example. The IED may include at least a controller (which in certain IEDs can be configured to run one or more applications simultaneously, serially, or both), firmware, a memory, a communications interface, and connectors that connect the IED to external systems, devices, and/or components at any voltage level, configuration, and/or type (e.g., AC, DC). At least certain aspects of the monitoring and control functionality of an IED may be embodied in a computer program that is accessible by the IED.

In some embodiments, the term “IED” as used herein may refer to a hierarchy of IEDs operating in parallel and/or tandem/series. For example, an IED may correspond to a hierarchy of a plurality of energy meters, power meters, and/or other types of resource meters. The hierarchy may comprise a tree-based hierarchy, such a binary tree, a tree having one or more child nodes descending from each parent node or nodes, or combinations thereof, wherein each node represents a specific IED. In some instances, the hierarchy of IEDs may share data or hardware resources and may execute shared software. It is understood that hierarchies may be non-spatial such as billing hierarchies where IEDs grouped together may be physically unrelated.

It is understood that an input is data or information that a processor and/or IED (e.g., the above-discussed plurality of IEDs) receives, and an output is data or information that a processor and/or IED sends. Inputs and outputs may either be digital or analog in nature. They may be digital signals (e.g., measurements in an IED coming from a sensor producing digital information/values) and/or analog signals (e.g., measurements in an IED coming from a sensor producing analog information/values). The digital and analog signals may be both discrete variables (e.g., two states such as high/low, one/zero, on/off, etc.) If digital, this may be a value. Alternatively, if analog, the presence of a voltage/current may be considered by the system/IED as an equivalent signal or continuous variables. Examples of continuous variables may include, for example, spatial position, temperature, pressure voltage, etc.). Digital and/or analog signals may include any processing step within the IED (e.g., derive an active power (kW), power factor, a magnitude, a relative phase angle, among all the derived calculations).

Processors and/or IEDs may convert/reconvert digital and analog input signals to a digital representation for internal processing. Processors and/or IEDs may also be used to convert/reconvert internally processed digital signals to digital and/or analog output signals to provide some indication, action, or other response (such as an input for another processor/IED). Typical uses of digital outputs may include signaling relays to open or close breakers or switches, signaling relays to start or stop motors and/or other equipment, and operating other devices and equipment that are able to directly interface with digital signals. Digital inputs are often used to determine the operational status/position of equipment (e.g., is a breaker open or closed, etc.) or read an input synchronous signal from a utility pulsed output. Analog outputs may be used to provide variable control of valves, motors, heaters, or other loads/processes in energy management systems. Finally, analog inputs may be used to gather variable operational data and/or in proportional control schemes.

A few more examples where digital and analog I/O data are leveraged may include, but are not limited to: turbine controls, plating equipment, fermenting equipment, chemical processing equipment, telecommunications, equipment, precision scaling equipment, elevators and moving sidewalks, compression equipment, waste water treatment equipment, sorting and handling equipment, plating equipment temperature/pressure data logging, electrical generation/transmission/distribution, robotics, alarm monitoring and control equipment, and Supervisory Control and Data Acquisition systems (e.g., power SCADA, industrial SCADA, building management, etc.), as a few examples.

As noted earlier in this disclosure, the energy-related signals captured/measured by the at least one waveform capture device (e.g., IED) may include I/O data. It is understood that the I/O data may take the form of digital I/O data, analog I/O data, or a combination digital and analog I/O data. The I/O data may convey status information, for example, and many other types of information, as will be apparent to one of ordinary skill in the art from discussions above and below.

It is understood that the terms “processor” and “controller” are sometimes used interchangeably herein. For example, a processor may be used to describe a controller. Additionally, a controller may be used to describe a processor.

It is understood that there are many features, advantages and aspects associated with the disclosed invention, as will be further appreciated from the discussions below.

### BRIEF DESCRIPTION OF THE DRAWINGS

The foregoing features of the disclosure, as well as the disclosure itself may be more fully understood from the following detailed description of the drawings, in which:

FIG. 1 shows an example electrical system in accordance with embodiments of the disclosure;

FIG. 2 illustrates examples of where data could be analyzed and extraneous waveform captures could be identified and reduced in accordance with embodiments of the disclosure;

FIG. 2A shows an example electrical system with Intelligent Electronic Devices (IEDs) installed, for example, for capturing and analyzing data associated with the electrical system;

FIG. 3 shows an example IED that may be used in an electrical system and provided in an electrical power monitoring system (EPMS) in accordance with embodiments of the disclosure;

FIG. 4 is a flowchart illustrating an example implementation of a method to automatically identify, analyze and reduce extraneous waveform captures (WFCs);

FIG. 5 is a flowchart illustrating an example implementation of a method to automatically identify and analyze extraneous waveform captures;

FIG. 6 shows self-comparisons of points inside the same WFC;

FIG. 7 is a flowchart illustrating an example implementation of a method to automatically identify and analyze extraneous waveform captures;

FIG. 8 illustrates two example WFCs suitable for comparison using the techniques disclosed herein;

FIG. 9 illustrates an example of three-phase conductors;

FIG. 10 illustrates an example of a WFC with no anomalies;

FIG. 11 illustrates an example WFC with a short transient;

FIG. 12 illustrates an example WFC with the WFC in FIG. 11 subtracted from the WFC in FIG. 10;

FIG. 13 illustrates an example WFC with noise superimposed on the signal (light gray line) and the noisy WFC subtracted from the WFC in FIG. 10 (black line);

FIG. 14 illustrates an example WFC with a transient and noise superimposed on the signal (light gray line) and the noisy WFC with the transient subtracted from the WFC in FIG. 10 (black line);

FIG. 15 illustrates an example waveform capture with a transient and noise superimposed on the signal (light gray line), the noisy WFC with the transient subtracted from the WFC in FIG. 10 (solid black line), and noise floors for both the positive and negative polarity of the WFC (dashed lines); and

FIG. 16 illustrates an example of an amplitude-shifted (DC offset) WFC with a transient and noise superimposed on the signal (light gray line), the noisy amplitude-shifted (DC offset) WFC with the transient subtracted from the WFC in FIG. 10 (solid black line), and noise floors adjusted for the amplitude-shift (DC offset) for both the positive and negative polarity of the WFC (horizontal dashed lines above and below the black line).

### DETAILED DESCRIPTION

The features and other details of the concepts, systems, and techniques sought to be protected herein will now be more particularly described. It will be understood that any specific embodiments described herein are shown by way of illustration and not as limitations of the disclosure and the concepts described herein. Features of the subject matter described herein can be employed in various embodiments without departing from the scope of the concepts sought to be protected.

For convenience, certain introductory concepts and terms used in the specification (and adopted from IEEE Standard 1159-2019) are collected here.

As used herein, the term “periodic event” is used to describe a non-random, non-arbitrary, planned, expected, intentional, or predicable electrical event. A periodic event typically occurs at regular or semi-regular intervals. It is understood that periodic waveforms may not be related to a particular electrical “event”. For example, the “steady state” operation of a system will produce waveforms with repeating or recurring values and noise (i.e., periodic waveforms).

As used herein, the term “aperiodic event” is used to describe a random, arbitrary, unplanned, unexpected, unintentional, or unpredicted electrical event (e.g., voltage sag, voltage swell, voltage transient, and even voltage interruption). An aperiodic event typically occurs non-cyclically, arbitrarily or without specific temporal regularity. For the sake of this disclosure, transients and voltage sags are considered to be aperiodic events (i.e., notching is deemed/considered a harmonic phenomenon).

As used herein, the term “transient” is used to describe a deviation of the voltage and/or current from the nominal value with a duration typically less than 1 cycle. Sub-categories of transients include impulsive (unidirectional polarity) and oscillatory (bidirectional polarity) transients.

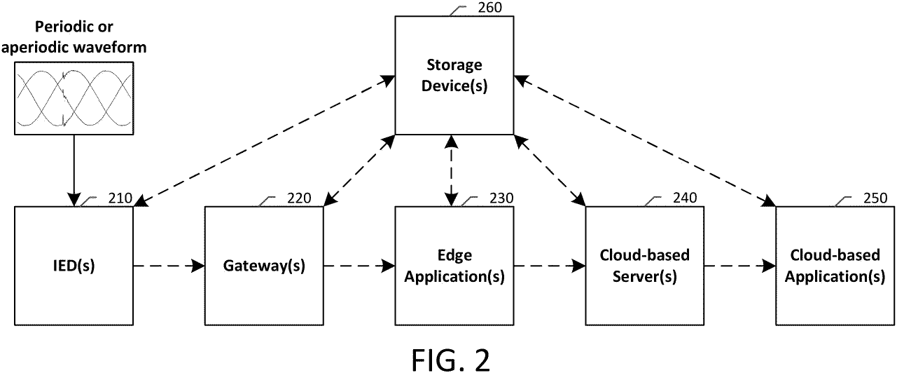

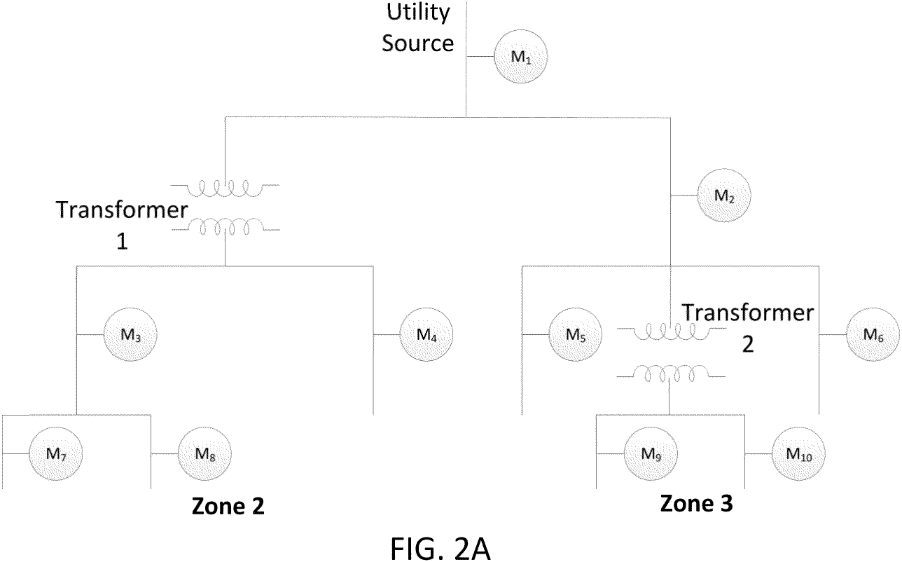

As briefly described in the Summary Section of this disclosure, and as will be further appreciated from discussions below, this invention automatically analyzes WFCs to determine whether anomalies or relevant changes exist over a WFC’s duration in at least part of at least one of the WFC’s voltage(s) and current(s) signals. If so, the WFC may be determined to be non-extraneous (e.g., containing relevant information to a real event); if not, the WFC may be determined to be extraneous, partially extraneous or provisional. If the comparison/analysis of a first WFC and a second WFC is marginal or does not provide a sufficient indication to determine whether the second WFC is not extraneous, extraneous, and/or partially extraneous, the second WFC may be categorized as provisional/indeterminant until a determination can be made either by an end-user/operator, expert, algorithm, and/or some other means. The above and below discussed WFCs may be captured using at least one waveform capture device in an electrical system, for example. Additional aspects of the disclosed invention will be appreciated from discussions related to the figures, particularly FIGS. 2-16.

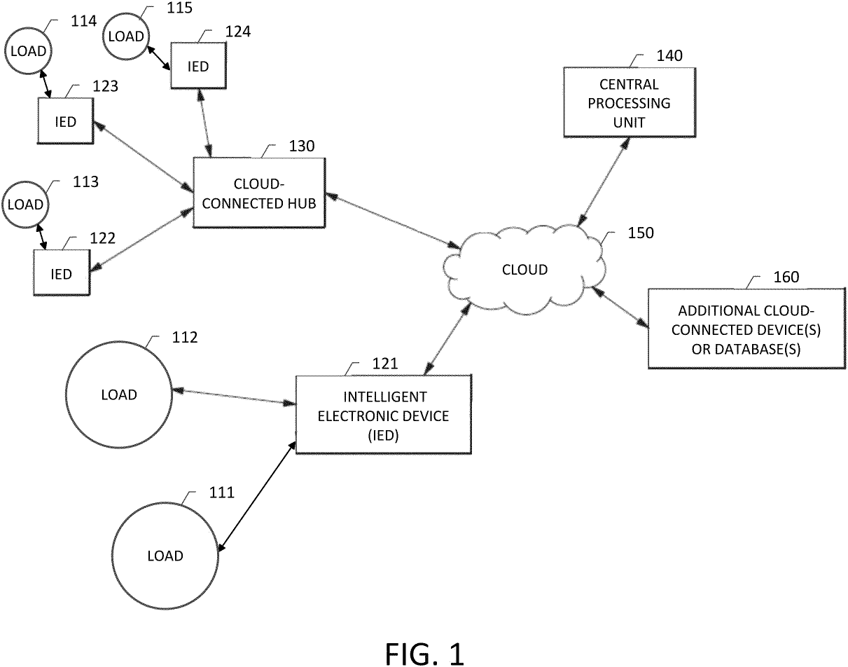

Referring to FIG. 1, an example electrical system in accordance with embodiments of the disclosure includes one or more loads (here, loads 111, 112, 113, 114, 115) (also sometimes referred to herein as “equipment” or “apparatuses”) and one or more intelligent electronic devices (IEDs) (here, IEDs 121, 122, 123, 124) capable of sampling, sensing or monitoring one or more parameters (e.g., power monitoring parameters) associated with the loads. In embodiments, the loads 111, 112, 113, 114, 115 and IEDs 121, 122, 123, 124 may be installed in one or more buildings or other physical locations or they may be installed on one or more processes and/or loads within a building. The buildings may correspond, for example, to commercial, industrial or institutional buildings.

As shown in FIG. 1, the IEDs 121, 122, 123, 124 are each coupled to one or more of the loads 111, 112, 113, 114, 115 (which may be located “upline” or “downline” from the IEDs in some embodiments). The loads 111, 112, 113, 114, 115 may include, for example, machinery or apparatuses associated with a particular application (e.g., an industrial application), applications, and/or process(es). The machinery may include electrical or electronic equipment, for example. The machinery may also include the controls and/or ancillary equipment associated with the equipment.

In embodiments, the IEDs 121, 122, 123, 124 may monitor and, in some embodiments, analyze parameters (e.g., energy-related parameters) associated with the loads 111, 112, 113, 114, 115 to which they are coupled. The IEDs 121, 122, 123, 124 may also be embedded within the loads 111, 112, 113, 114, 115 in some embodiments. According to various aspects, one or more of the IEDs 121, 122, 123, 124 may be configured to monitor utility feeds, including surge protective devices (SPDs), trip units, active filters, lighting, IT equipment, motors, and/or transformers, which are some examples of loads 111, 112, 113, 114, 115, and the IEDs 121, 122, 123, 124, and may detect ground faults, voltage sags, voltage swells, momentary interruptions and oscillatory transients, as well as fan failure, temperature, arcing faults, phase-to-phase faults, shorted windings, blown fuses, and harmonic distortions, which are some example parameters that may be associated with the loads 111, 112, 113, 114, 115. The IEDs 121, 122, 123, 124 may also monitor devices, such as generators, including input/outputs (I/Os), protective relays, battery chargers, and sensors (for example, water, air, gas, steam, levels, accelerometers, flow rates, pressures, and so forth).

According to another aspect, the IEDs 121, 122, 123, 124 may detect overvoltage, undervoltage, or transient overvoltage conditions, as well as other parameters such as temperature, including ambient temperature. According to a further aspect, the IEDs 121, 122, 123, 124 may provide indications of monitored parameters and detected conditions that can be used to control the loads 111, 112, 113, 114, 115 and other equipment in the electrical system in which the loads 111, 112, 113, 114 and IEDs 121, 122, 123, 124 are installed. A wide variety of other monitoring and/or control functions can be performed by the IEDs 121, 122, 123, 124, and the aspects and embodiments disclosed herein are not limited to IEDs 121, 122, 123, 124 operating according to the above-mentioned examples.

It is understood that the IEDs 121, 122, 123, 124 may take various forms and may each have an associated complexity (or set of functional capabilities and/or features). For example, IED 121 may correspond to a “basic” IED, IED 122 may correspond to an “intermediate” IED, and IED 123 may correspond to an “advanced” IED. In such embodiments, intermediate IED 122 may have more functionality (e.g., energy measurement features and/or capabilities) than basic IED 121, and advanced IED 123 may have more functionality and/or features than intermediate IED 122. For example, in embodiments IED 121 (e.g., an IED with basic capabilities and/or features) may be capable of monitoring instantaneous voltage, current energy, demand, power factor, averages values, maximum values, instantaneous power, and/or long-duration rms variations, and IED 123 (e.g., an IED with advanced capabilities) may be capable of monitoring additional parameters such as voltage transients, voltage fluctuations, frequency slew rates, harmonic power flows, and discrete harmonic components, all at higher sample rates, etc. It is understood that this example is for illustrative purposes only, and likewise in some embodiments an IED with basic capabilities may be capable of monitoring one or more of the above energy measurement parameters that are indicated as being associated with an IED with advanced capabilities. It is also understood that in some embodiments the IEDs 121, 122, 123, 124 each have independent functionality.

In the example embodiment shown, the IEDs 121, 122, 123, 124 are communicatively coupled to a central processing unit 140 via the “cloud” 150. In some embodiments, the IEDs 121, 122, 123, 124 may be directly communicatively coupled to the cloud 150, as IED 121 is in the illustrated embodiment. In other embodiments, the IEDs 121, 122, 123, 124 may be indirectly communicatively coupled to the cloud 150, for example, through an intermediate device, such as a cloud-connected hub 130 (or a gateway), as IEDs 122, 123, 124 are in the illustrated embodiment. The cloud-connected hub 130 (or the gateway) may, for example, provide the IEDs 122, 123, 124 with access to the cloud 150 and the central processing unit 140. It is understood that not all IED’s have a connection with (or are capable of connecting with) the cloud 150 (directly or non-directly). In embodiments is which an IED is not connected with the cloud 150, the IED may be communicating with a gateway, edge software or possibly no other devices (e.g., in embodiments in which the IED is processing data locally).

As used herein, the terms “cloud” and “cloud computing” are intended to refer to computing resources connected to the Internet or otherwise accessible to IEDs 121, 122, 123, 124 via a communication network, which may be a wired or wireless network, or a combination of both. The computing resources comprising the cloud 150 may be centralized in a single location, distributed throughout multiple locations, or a combination of both. A cloud computing system may divide computing tasks amongst multiple racks, blades, processors, cores, controllers, nodes or other computational units in accordance with a particular cloud system architecture or programming. Similarly, a cloud computing system may store instructions and computational information in a centralized memory or storage, or may distribute such information amongst multiple storage or memory components. The cloud system may store multiple copies of instructions and computational information in redundant storage units, such as a RAID array.

The central processing unit 140 may be an example of a cloud computing system, or cloud-connected computing system. In embodiments, the central processing unit 140 may be a server located within buildings in which the loads 111, 112, 113, 114, 115, and the IEDs 121, 122, 123, 124 are installed, or may be remotely-located cloud-based service. The central processing unit 140 may include computing functional components similar to those of the IEDs 121, 122, 123, 124 is some embodiments, but may generally possess greater numbers and/or more powerful versions of components involved in data processing, such as processors, memory, storage, interconnection mechanisms, etc. The central processing unit 140 can be configured to implement a variety of analysis techniques to identify patterns in received measurement data from the IEDs 121, 122, 123, 124, as discussed further below. The various analysis techniques discussed herein further involve the execution of one or more software functions, algorithms, instructions, applications, and parameters, which are stored on one or more sources of memory communicatively coupled to the central processing unit 140. In certain embodiments, the terms “function,” “algorithm,” “instruction,” “application,” or “parameter” may also refer to a hierarchy of functions, algorithms, instructions, applications, or parameters, respectively, operating in parallel and/or tandem. A hierarchy may comprise a tree-based hierarchy, such a binary tree, a tree having one or more child nodes descending from each parent node, or combinations thereof, wherein each node represents a specific function, algorithm, instruction, application, or parameter.

In embodiments, since the central processing unit 140 is connected to the cloud 150, it may access additional cloud-connected devices or databases 160 via the cloud 150. For example, the central processing unit 140 may access the Internet and receive information such as weather data, utility pricing data, or other data that may be useful in analyzing the measurement data received from the IEDs 121, 122, 123, 124. In embodiments, the cloud-connected devices or databases 160 may correspond to a device or database associated with one or more external data sources. Additionally, in embodiments, the cloud-connected devices or databases 160 may correspond to a user device from which a user may provide user input data. A user may view information about the IEDs 121, 122, 123, 124 (e.g., IED manufacturers, models, types, etc.) and data collected by the IEDs 121, 122, 123, 124 (e.g., energy usage statistics) using the user device. Additionally, in embodiments the user may configure the IEDs 121, 122, 123, 124 using the user device.

In embodiments, by leveraging the cloud-connectivity and enhanced computing resources of the central processing unit 140 relative to the IEDs 121, 122, 123, 124, sophisticated analysis can be performed on data retrieved from one or more IEDs 121, 122, 123, 124, as well as on the additional sources of data discussed above, when appropriate. This analysis can be used to dynamically control one or more parameters, processes, conditions or equipment (e.g., loads) associated with the electrical system.

In embodiments, the parameters, processes, conditions or equipment are dynamically controlled by a control system associated with the electrical system. In embodiments, the control system may correspond to or include one or more of the IEDs 121, 122, 123, 124 in the electrical system, central processing unit 140 and/or other devices within or external to the electrical system. One or more of the IEDs 121, 122, 123, 124 and/or other components in the above-discussed electrical system may additionally or alternatively be provided in or be associated with an Electrical Power Monitoring System (EPMS). The EPMS may include software, communications systems and devices, and/or cloud-based components, such as those discussed above, in some embodiments.

Referring to FIGS. 2 and 2A, FIG. 2 illustrates examples of where data (e.g., energy-related waveforms) could be analyzed and extraneous WFCs could be identified and reduced in accordance with embodiments of the disclosure. Additionally, FIG. 2A is a simplified single line diagram (SLD) showing an example electrical system with IEDs installed, for example, for capturing and analyzing data associated with the electrical system. The IEDs may be provided in or be associated with an EPMS in some instances. As illustrated in FIG. 2A, an electrical system may incorporate a diverse array of IEDs that are installed throughout the electrical system. These IEDs may have different levels of capabilities and feature sets; some more and some less. For example, energy consumers often install high-end (advanced capabilities) IEDs at the location where electrical energy enters their premises (M₁ in FIG. 2A). This is done to acquire the broadest and deepest understanding possible of the electrical signals’ quality and quantity as received from the source (typically, the utility). Because the budget for metering may be fixed and the energy consumer often wants to meter as broadly as possible across their electrical system, economic practicality generally stipulates installing IEDs with lower capabilities as the installed metering points get closer to the loads. Because of this, the majority of facilities incorporate more low/mid-range IEDs than high-end IEDs.

“High-end” metering platforms (and some “mid-range” metering platforms) are more expensive and generally capable of capturing sophisticated PQ phenomena including high-speed voltage events. “Low-end” metering platforms are less expensive and generally have more limited processor bandwidth, sample rates, memory, and/or other capabilities as compared to high-end IEDs. The emphasis of low-end IEDs, including energy measurements taken in most breakers, UPSs, VSDs, etc., is typically energy consumption or other energy-related functions, and perhaps some very basic power quality phenomena (e.g., steady-state quantities such as imbalance, overvoltage, undervoltage, etc.). In short, an electrical system may incorporate a variety of IEDs, with each of the IEDs configured to monitor one or more aspects of the electrical system.

As noted in the Summary section of this disclosure, and as will be discussed further below, energy-related waveforms captured by IEDs (i.e., WFCs such as voltage(s), current(s), etc.) in an electrical system may be analyzed and extraneous WFCs could be identified and reduced substantially anywhere, for example, including in at least one IED responsible for capturing the energy-related waveforms. It is also understood that captured energy-related waveforms (i.e., WFCs) can be sent as uncompressed waveform capture(s) to the Edge, Gateway, and/or Cloud and be analyzed and extraneous WFCs could be identified and reduced there. For example, as shown in FIG. 2, captured energy-related waveforms (i.e., WFCs) can be analyzed and extraneous WFCs could be identified and reduced on at least one IED 210, at least one gateway 220, at least one edge application 230, at least one cloud-based server 240, at least one cloud-based application 250 and/or at least one storage means 260. It is understood that the analysis of the captured energy-related waveforms and the identification and reduction of the extraneous WFCs could occur in one or more additional or alternative systems and devices other than those shown in FIG. 2. For example, while the system illustrated in FIG. 2 is shown as including at least one gateway 220, it is understood that in some instances the system may not include the at least one gateway 220. It is understood that in accordance with various aspects of this disclosure, the focus of the disclosed invention is on the analysis of the captured energy-related waveforms (i.e., WFCs) and the identification and reduction of the extraneous WFCs; not so much where it occurs.

In accordance with some embodiments of this disclosure, the at least one IED 210 shown in FIG. 2 is configured to capture/generate one or more energy-related WFCs in the electrical system from voltage and/or current signals. For example, the at least one IED 210 may include at least one voltage and/or current measurement device configured to measure the voltage and/or current signals in the electrical system, and the at least one IED 210 may generate one or more energy-related WFCs from or using the measured voltage and/or current signals.

It is understood that during normal operation of an EPMS, which may include IEDs and other types of devices, as noted above, numerous energy-related WFCs may be captured by multiple devices (e.g., at least one IED 210), producing large amounts of data to be stored (e.g., gigabytes, terabytes, etc.), maintained, retrieved, analyzed, and so forth. It is therefore an object of the invention disclosed herein to identify and reduce extraneous WFCs, for example, to decrease the size of energy-related WFC files (individually or in groups).

For example, as noted in the Background section of this disclosure, a device capturing a set of waveforms from six channels with a length of ten cycles and a sample rate of one thousand twenty-four samples/cycles/channels, for example, will result in a file of approximately one hundred and twenty kilobytes (KB). In one example implementation of the invention disclosed herein, identification and reduction of extraneous WFCs may reduce the memory requirement (i.e., provide for a data storage reduction).

Returning now to FIG. 2, the energy-related waveform captured by the at least one IED 210, which may be periodic and/or aperiodic, may be analyzed on or using a variety of devices and/or techniques to identify and reduce extraneous WFCs. For example, as illustrated in FIG. 2, the at least one captured energy-related waveform may be analyzed on or using one or more of the at least one IED 210, the at least one gateway 220, the at least one edge application 230, the at least one cloud-based server 240, the at least one cloud-based application 250 and the at least one storage means 260. For example, the at least one IED 210 may employ algorithms to identify and reduce extraneous WFCs. Alternatively, the waveform captured by the at least one IED 210 may be passed to a subsequent element (e.g., gateway 220, Edge application 230, Cloud-based application 250, etc.) for analysis and identification and reduction of extraneous WFCs.

It is understood that the at least one storage means 260 may be located at any point in the system. For example, the at least one storage means 260 may be provided in, or be associated with, at least one of the at least one IED 210, the at least one gateway 220, the at least one edge application 230, the at least one cloud-based server 240, and the at least one cloud-based application 250 in some embodiments. In one example implementation, the waveform capture could be stored in the at least one IED 210 and/or passed to the at least one edge application 230 for storage and so forth. It is understood that the at least one storage means 260 may additionally or alternatively be provided as or correspond to a storage means that is separate from the at least one IED 210, the at least one gateway 220, the at least one edge application 230, the at least one cloud-based server 240, and the at least one cloud-based application 250.

Additional aspects of analysis and identification and reduction of extraneous WFCs will be appreciated from further discussions below.

It is understood that specific applications may use all of the elements, additional elements, different elements, or fewer elements shown in FIG. 2 and other figures to provide the same or similar results. For example, in one example implementation systems for analyzing, identifying and reducing extraneous WFCs in accordance with embodiments of the disclosure may not employ a gateway (e.g., 220) and/or cloud-based connection (e.g., to cloud-based server(s) and/or cloud-based application(s) such as 240, 250). Instead, the systems (e.g., EPMSs) may interconnect at least one IED (e.g., 210) with an Edge application (e.g., 240) via an Ethernet Modbus/TCP interconnection, for example.

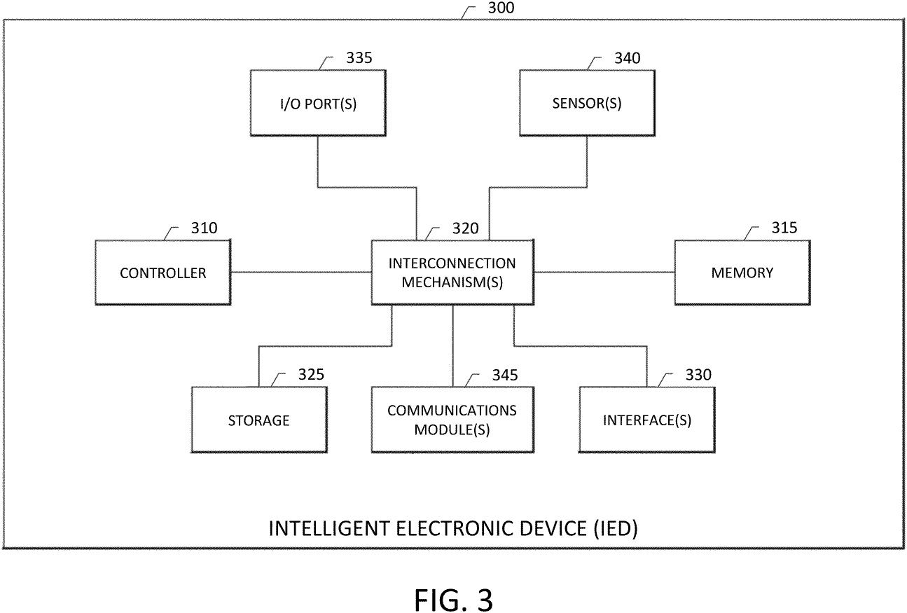

Referring to FIG. 3, an example IED 300 that may be suitable for use in the electrical system shown in FIG. 1, and/or the system shown in FIG. 2, for example, to capture, process, store and/or compress energy-related WFCs, includes a controller 310, a memory device 315, storage 325, and an interface 330. The IED 300 also includes an input-output (I/O) port 335, a sensor 340, a communication module 345, and an interconnection mechanism 320 for communicatively coupling two or more IED components 310-345.

The memory device 315 may include volatile memory, such as DRAM or SRAM, for example. The memory device 315 may store programs and data collected during operation of the IED 300. For example, in embodiments in which the IED 300 is configured to monitor or measure one or more electrical parameters associated with one or more loads (e.g., 111, shown in FIG. 1) in an electrical system, the memory device 315 may store the monitored electrical parameters.

The storage system 325 may include a computer readable and writeable nonvolatile recording medium, such as a disk or flash memory, in which signals are stored that define a program to be executed by the controller 310 or information to be processed by the program. The controller 310 may control transfer of data between the storage system 325 and the memory device 315 in accordance with known computing and data transfer mechanisms. In embodiments, the electrical parameters monitored or measured by the IED 300 may be stored in the storage system 325.

The I/O port 335 can be used to couple loads (e.g., 111, shown in FIG. 1) to the IED 300, and the sensor 340 can be used to monitor or measure the electrical parameters associated with the loads. The I/O port 335 can also be used to coupled external devices, such as sensor devices (e.g., temperature and/or motion sensor devices) and/or user input devices (e.g., local or remote computing devices) (not shown), to the IED 300. The external devices may be local or remote devices, for example, a gateway (or gateways). The I/O port 335 may further be coupled to one or more user input/output mechanisms, such as buttons, displays, acoustic devices, etc., to provide alerts (e.g., to display a visual alert, such as text and/or a steady or flashing light, or to provide an audio alert, such as a beep or prolonged sound) and/or to allow user interaction with the IED 300.

The communication module 345 may be configured to couple the IED 300 to one or more external communication networks or devices. These networks may be private networks within a building in which the IED 300 is installed, or public networks, such as the Internet. In embodiments, the communication module 345 may also be configured to couple the IED 300 to a cloud-connected hub (e.g., 130, shown in FIG. 1), or to a cloud-connected central processing unit (e.g., 140, shown in FIG. 1), associated with an electrical system including IED 300.

The IED controller 310 may include one or more processors that are configured to perform specified function(s) of the IED 300. The processor(s) can be a commercially available processor, such as the well-known PentiumTM, CoreTM, or AtomTM class processors available from the Intel Corporation. Many other processors are available, including programmable logic controllers. The IED controller 310 can execute an operating system to define a computing platform on which application(s) associated with the IED 300 can run.

In embodiments, the electrical parameters monitored or measured by the IED 300 may be received at an input of the controller 310 as IED input data, and the controller 310 may process the measured electrical parameters to generate IED output data or signals at an output thereof. In embodiments, the IED output data or signals may correspond to an output of the IED 300. The IED output data or signals may be provided at I/O port(s) 335, for example. In embodiments, the IED output data or signals may be received by a cloud-connected central processing unit, for example, for further processing (e.g., to identify, track and analyze power quality events), and/or by equipment (e.g., loads) to which the IED is coupled (e.g., for controlling one or more parameters associated with the equipment, as will be discussed further below). In one example, the IED 300 may include an interface 330 for displaying visualizations indicative of the IED output data or signals and/or for selecting configuration parameters (e.g., waveform capture and/or compression parameters) for the IED 300. The interface 330 may correspond to a graphical user interface (GUI) in embodiments.

Components of the IED 300 may be coupled together by the interconnection mechanism 320, which may include one or more busses, wiring, or other electrical connection apparatus. The interconnection mechanism 320 may enable communications (e.g., data, instructions, etc.) to be exchanged between system components of the IED 300.

It is understood that IED 300 is but one of many potential configurations of IEDs in accordance with various aspects of the disclosure. For example, IEDs in accordance with embodiments of the disclosure may include more (or fewer) components than IED 300. Additionally, in embodiments one or more components of IED 300 may be combined. For example, in embodiments memory 315 and storage 325 may be combined.

It is understood that WFCs, such as may be captured by IED 300, for example, are high-speed measurements and recordings of voltage and/or current signals that can be triggered using many methods including: manually, automatically after exceeding one or more parameter threshold(s), periodically (e.g., at 12:00pm daily), initiated by an external input (e.g., change in digital status input signal), or by some other means. The invention disclosed herein, as will be appreciated from further discussions below, automatically analyzes and reduces extraneous WFCs.

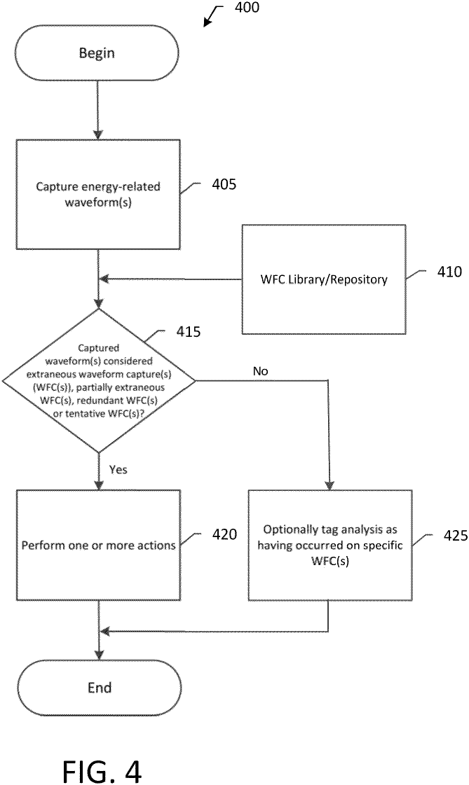

Referring to FIG. 4 and other figures, several flowcharts (or flow diagrams) are shown to illustrate example methods (here, methods 400, 500, 700) of the disclosure relating to automatically identifying, analyzing and reducing extraneous WFCs. Rectangular elements (typified by element 405 in FIG. 4), as may be referred to herein as “processing blocks,” may represent computer software and/or IED algorithm instructions or groups of instructions. Diamond shaped elements (typified by element 410 in FIG. 4), as may be referred to herein as “decision blocks,” represent computer software and/or IED algorithm instructions, or groups of instructions, which affect the execution of the computer software and/or IED algorithm instructions represented by the processing blocks. The processing blocks and decision blocks (and other blocks shown) can represent steps performed by functionally equivalent circuits such as a digital signal processor circuit or an application specific integrated circuit (ASIC).

The flowcharts do not depict the syntax of any particular programming language. Rather, the flowcharts illustrate the functional information one of ordinary skill in the art requires to fabricate circuits or to generate computer software to perform the processing required of the particular apparatus. It should be noted that many routine program elements, such as initialization of loops and variables and the use of temporary variables are not shown. It will be appreciated by those of ordinary skill in the art that unless otherwise indicated herein, the particular sequence of blocks described is illustrative only and can be varied. Thus, unless otherwise stated, the blocks described below are unordered; meaning that, when possible, the blocks can be performed in any convenient or desirable order including that sequential blocks can be performed simultaneously (e.g., run parallel on multiple processors and/or multiple IEDs) and vice versa. Additionally, the order/flow of the blocks may be rearranged and/or interchanged in some cases as well. It will also be understood that various features from the flowcharts described below may be combined in some embodiments. Thus, unless otherwise stated, features from one of the flowcharts described below may be combined with features of other ones of the flowcharts described below, for example, to capture the various advantages and aspects of systems and methods associated with automatically identifying, analyzing and reducing extraneous WFCs sought to be protected by this disclosure. It is also understood that various features from the flowchart described below may be separated in some embodiments. For example, while the flowcharts illustrated in FIGS. 4, 5 and 7 are shown having many blocks, in some embodiments the methods shown by these flowcharts may include fewer blocks or steps.

Referring to FIG. 4, a flowchart illustrates an example method 400 to automatically identify, analyze and reduce extraneous WFCs, for example, to reduce the memory requirements, superfluous analyses, comms bandwidth, and/or processing requirements for WFCs in EPMSs. As noted earlier in this disclosure, EPMSs may include IEDs and various other types of devices. In accordance with some embodiments of this disclosure, method 400 may be implemented on a processor of at least one IED (e.g., 121, shown in FIG. 1) in the electrical system and/or remote from the at least one IED, for example, in at least one of: a cloud-based system, on-site/edge software, a gateway, or another head-end system.

As illustrated in FIG. 4, the method 400 begins at block 405, where at least one energy-related waveform is captured/measured using at least one IED in an electrical system. The at least one IED may be installed or located, for example, at a respective metering point of a plurality of metering points in the electrical system. In some embodiments, the at least one IED may be coupled to one or more loads/equipment/apparatuses (e.g., induction motors, variable speed drives, etc.) in the electrical system, and the energy-related waveform(s) captured by the at least one IED may be associated with the operation of the loads/equipment/apparatuses to which the at least one IED is coupled. The energy-related waveform(s) may include, for example, at least one of: voltage waveform(s), current waveform(s), power waveform(s), derivatives or integrals of a voltage or current, current and/or power waveform(s), power factor(s), and any (or substantially any) other energy-related waveform information derived from the voltage and/or current signatures. The voltage and/or current waveform(s) may include, for example, single-phase or polyphase voltage and current waveforms, neutral voltage(s), neutral current(s), ground current(s), and so forth. More detailed definitions and examples of the energy-related waveform(s) (e.g., voltage and/or current waveform(s)) are described in the Summary Section of this disclosure, for example.

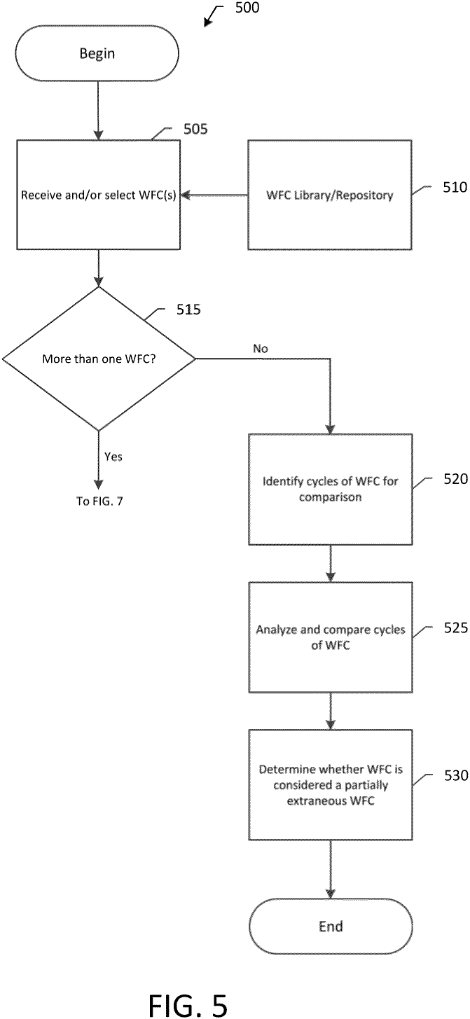

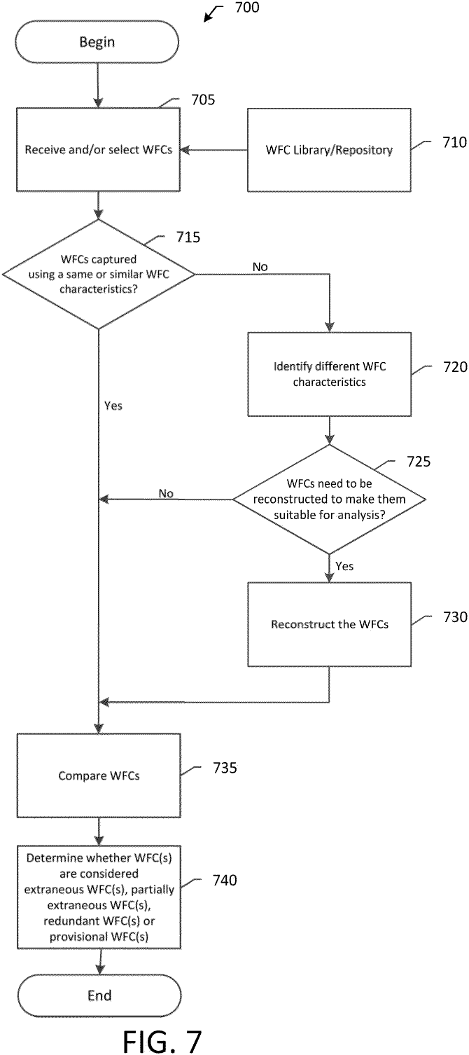

At block 415, the at least one captured energy-related waveform is analyzed and one or more comparisons are made to determine whether the at least one captured energy-related waveform meets the criteria of being considered an extraneous WFC, a partially extraneous WFC, a redundant WFC, or a provisional WFC. More detailed aspects relating to this determination are discussed further below, for example, in connection with methods 500 and 700 shown in FIGS. 5 and 7, respectively. However, let it suffice here to note that in some instances the analysis and one or more comparisons may include analysis and comparisons between the at least one captured energy-related waveform and one or more other WFCs and/or models, such as WFCs and/or models from a WFC library repository 410. As such, the WFCs and/or models may be provided as an input (or inputs) to block 415. Let is also suffice here to note that the criteria of being considered an extraneous WFC, a partially extraneous WFC, a redundant WFC, or a provisional WFC, may be based on a variety of factors and in response to various analyses. It is notable that these factors and analyses may be based, at least in part, on at least one of: load type(s), load mix(es), process(es), application(s), customer type(s)/segment(s), memory requirement(s), and cost(s), etc. in some embodiments, as will be appreciated from further discussions below.

If the at least one captured energy-related waveform is evaluated and determined to meet the criteria of being considered an extraneous WFC, a partially extraneous WFC, a redundant WFC, or a provisional WFC at block 415, the method may proceed to block 420. At block 420, one or more actions may be performed. For example, in accordance with some embodiments of this disclosure, at least one of the following actions may be performed: deleting/removing the extraneous WFC(s), tagging/indicating (e.g., as extraneous, questionable, redundant, etc.) the extraneous WFC(s), recommending and/or updating waveform capture setting(s)/configuration(s) for/in the at least one waveform capture device capturing the extraneous WFC(s), lowering/reducing the priority/importance (e.g., lower priority for analysis, processing, transmitting, etc.) of the extraneous WFC(s), and compressing the extraneous WFCs. One example way of compressing WFCs that may be used to compress the extraneous WFCs is described in co-pending U.S. Patent App. No. 17/522,170, entitled “Systems and methods for optimizing waveform capture compression and characterization,” which is assigned to the same assignee as the present disclosure.

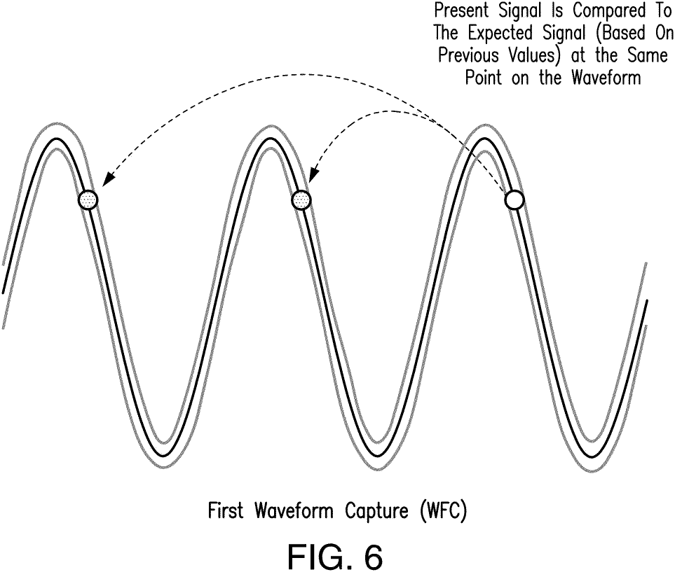

In accordance with some embodiments of this disclosure, if the WFC is tagged as extraneous or provisional, an operator may review and validate the WFC is not useful (or this function may be automatically performed). An important aspect of this “tagging” action is that the operator (who may not be an expert in WFC analysis) may be automatically provided/informed/indicated that an “independent” analysis has been performed on the WFC by the system and the WFC is not considered relevant or distinctive from a previously analyzed WFC based on this analysis and may be ignored as desired. In this case, the system may append a tag to the previously analyzed WFC indicating the analyzed WFC as an original, redundant, or extraneous WFC. As such, all extraneous or provisional WFCs are able to receive a tag when referring to a previously analyzed WFC, which then becomes a reference and may be added into a library as the “typical” or “reference” WFC. The analysis of this extraneous WFC may be used, for example, to enable an end-user/expert to visualize these and confirm their redundancy and/or enable the system to adjust a “tolerance or threshold envelope” around the WFC showing the thresholds for indicating an ongoing event (e.g., the two gray lines shown in FIG. 6, as will be discussed further below) of the reference WFC.

In accordance with some embodiments of this disclosure, one or more additional actions may be taken subsequent to and/or in parallel to performing the above-discussed action(s). For example, associated alarm data may be extracted and analyzed, data may be used for other purposes such as a sample of the system’s post-event response, other settings may be changed in association with alarm settings for smarter alarms and alarm prioritization, information may be used to enhance segment-related analytics in cloud-based applications, etc. It is understood that other data originating in the at least one waveform capture device (or elsewhere in an EPMS) may optionally be considered as extraneous along with the associated WFC. Examples of the other data may include, for example, data associated with an event that is associated with the WFC. In accordance with some embodiments of this disclosure, the other data is evaluated to avoid deleting important information associated with the WFC, such as alarm information associated with an event that may be critical for future analyses.

Returning now to block 415, if it is determined the at least one captured energy-related waveform does not meet the criteria of being considered an extraneous WFC, a partially extraneous WFC, a redundant WFC, or a provisional WFC, the method may end in some embodiments or one or more additional actions may be performed (e.g., at block 425). For example, at block 425, the analysis may optionally be tagged to indicate the WFC has been analyzed. Alternatively, the optional tagging may provide additional information to the WFC (e.g., metadata, event data, alarm data, data and/or information from other IEDs, etc.) In certain implementations, this new distinctive WFC will be added into a library to be used to identify future new WFCs against all known WFCs (reference to detect any extraneous, redundant, or provisional WFCs).

Subsequent to blocks 415, 420 and/or 425, the method may end in some embodiments. In other embodiments, the method may return to block 405 and repeat again (e.g., for capturing additional energy-related waveforms). In some embodiments in which the method ends after blocks 415, 420 or 425, the method may be initiated again in response to user input, automatically, periodically, and/or a control signal, for example.

It is understood that method 400 may include one or more additional blocks or steps in some embodiments, as will be apparent to one of ordinary skill in the art. For example, in some embodiments, one or more actions may be taken or performed based on or using the at least one captured energy-related waveform. For example, the at least one captured energy-related waveform, and information associated with the at least one captured energy-related waveform (e.g., metadata), may be stored and/or displayed.

Other example aspects of this invention are described below in connection with methods 500 and 600, for example.

Referring to FIG. 5, a flowchart illustrates an example method 500 for analyzing WFCs, for example, to determine whether a WFC meets the criteria of being deemed/considered a partially extraneous WFC (i.e., at least a portion of the WFC is deemed/considered extraneous). In accordance with some embodiments of this disclosure, method 500 illustrates example steps that may be performed in one or more blocks (e.g., block 410) of method 400 discussed above. Similar to method 400, method 500 may be implemented, for example, on a processor of at least one IED (e.g., 121, shown in FIG. 1) and/or remote from the at least IED, for example, in at least one of: a cloud-based system, on-site software/edge, a gateway, or another head-end system.

As illustrated in FIG. 5, the method 500 begins at block 505 were one or more WFCs may be received and/or selected for future analysis and comparisons. For example, a single WFC may compared to itself (e.g., cycles of the single WFC may be compared with each other, as described further below), or multiple WFCs may be compared with each other (as also described further below). In some example implementations, the WFCs received and/or selected at block 505 may correspond to or include new or recently captured WFCs (e.g., WFC(s) captured at block 405 of method 400). Additionally, in some example implementations, the WFCs received and/or selected at block 505 may correspond to or include other WFCs (i.e., WFCs other than new or recently captured WFCs), such as WFCs received and/or selected from a WFC library or repository 510. In another example implementation, a model may also be loaded (e.g., from the WFC library or repository 510) and used as a reference. This model may be composed of a signal and/or a bandwidth, as described further below in connection with FIGS. 6 and 7.

At block 515, the received and/or selected WFC(s) may be processed to determine if there is more than one WFC to be further analyzed. If it is determined there is not more than one WFC (i.e., there is just one WFC) to be further analyzed, the method 500 may proceed to block 520 (e.g., for comparing cycles of the single WFC). Alternatively, if it is determined there is more than one WFC to be further analyzed, one or more additional steps may be taken. For example, in one implementation, if it is determined there is more than one WFC, the method 500 may proceed to one or more of the steps associated with method 700 shown in FIG. 7 (e.g., block 705 of method 700).

At block 520, cycles of the single WFC that may be suitable for a cycle to cycle to comparison are identified. For example, the single WFC may be sliced into cycles (or any other subpart) so as to identify partially extraneous cycles/sub-parts. More particularly, at block 525, the cycles identified at block 520 may be analyzed and compared, for example, for determining at block 530 whether the WFC meets the criteria of being considered a partially extraneous WFC (i.e., at least a portion of the WFC is deemed/considered extraneous). For example, in one implementation a point-by-point comparison may be performed between: at least one data point in at least one first cycle of the WFC, and one or more corresponding data points on at least one second cycle of the WFC, at block 520 to determine whether the WFC meets the criteria of being deemed/considered a partially extraneous WFC. This point-by-point comparison of the waveforms may be considered a “time domain comparison” approach. For example, FIG. 6 illustrates an exemplary first WFC where the signal is very clean (dark black line). It is possible to compare data point between one or more cycles to determine whether any of the consecutive cycles are extraneous. In some cases (e.g., memory/storage conservation, reduced comms bandwidth, processing bandwidth, etc.), it may be useful to reduce the first WFC by one or more cycles to minimize its memory requirements (i.e., the WFC may be reduced in size). The waveform data selected to be removed (if feasible and possible) would often be at the beginning, end, or beginning and end of the first WFC and last WFC to ensure all cycles in the resulting WFC are consecutive.

In accordance with some embodiments of this disclosure, the compared data points may be acquired/measured or derived. Again, a selected cycle’s data point may be compared to one or more previous cycle’s corresponding data points, an average or range of one or more previous cycle’s corresponding data points, an arbitrary previous cycle(s)’s corresponding data point, an interpolated data point, or some other measured or derived data point that is useful for comparison. If a WFC is evaluated and no changes are determined to have occurred (or only minimal changes occur based on the feature’s configuration), the WFC may be deemed to be a partially extraneous WFC and appropriate action(s) may be taken (e.g., at block 415 of method 400).

Referring again to FIG. 6, which illustrates one example implementation of this feature in accordance embodiments of this disclosure, the solid black line shown in FIG. 6 is one phase of a WFC (e.g., a single current or voltage signal). The two gray lines shown in the same illustration are a “tolerance or threshold envelope” around the WFC showing the thresholds for indicating an abnormal event. In accordance with some embodiments of this disclosure, if a data point exceeds (above, below our outside of) the threshold envelope, the WFC may be considered as non-extraneous. Additionally, in accordance with some embodiments of this disclosure, if the data points stay inside the threshold envelope for the WFC’s duration (or are mostly within the envelope for the WFC’s duration), the WFC may be considered a partially or fully extraneous WFC. In accordance with some embodiments of this disclosure, it is possible for the WFC to be considered as “fully” extraneous if the entirety of the WFC is inside of the threshold lines.

It should be noted that additional analysis may need to be performed at block 525 to determine whether the WFC meets the criteria of being deemed/considered a partially or fully extraneous WFC. It should also be noted that other means of determining whether the WFC meets the criteria of being deemed/considered a partially or fully extraneous WFC are contemplated by this disclosure, as will be appreciated from further discussions below.

Subsequent to block 530, the method may end in some embodiments. In other embodiments, the method may return to block 505 and repeat again (e.g., for analyzing a new WFC). In some embodiments in which the method ends after block 530, the method may be initiated again in response to user input, automatically, and/or a control signal, for example.

It is understood that method 500 may include one or more additional blocks or steps in some embodiments, as will be apparent to one of ordinary skill in the art. It is also understood that in embodiments in which the method 500 is performed in conjunction with method 400 discussed above, for example, subsequent to method 500 completing, information from one or more of the steps performed in method 500 may be used in method 400. For example, subsequent to block 530 of method 500, the steps illustrated by blocks 415 and/or 420 of method 400 may be performed based on or in response to the information from block 530 and/or other blocks of method 500.

Referring to FIG. 7, a flowchart illustrates an example method 700 for analyzing WFCs, for example, to determine whether the WFCs meet the criteria of being considered extraneous WFCs. In accordance with some embodiments of this disclosure, method 700 illustrates example steps that may be performed in connection with methods 400 and 500 discussed above. For example, in one example implementation, method 700 may correspond to example steps that may be performed subsequent to block 515 of method 500. Similar to methods 400 and 500, method 700 may be implemented, for example, on a processor of at least one IED (e.g., 121, shown in FIG. 1) and/or remote from the at least IED, for example, in at least one of: a cloud-based system, on-site software/edge, a gateway, or another head-end system.

As illustrated in FIG. 7, the method 700 begins at block 705 were a plurality of WFCs may be received and/or selected for analysis. In some example implementations, one or more of the plurality of received and/or selected WFCs may correspond to or include new or recently captured WFCs (e.g., WFC(s) captured at block 405 of method 400). Additionally, in some example implementations, one or more of the plurality of received and/or selected WFCs may correspond to or include other WFCs (i.e., WFCs other than new or recently captured WFCs), such as WFCs received and/or selected from a WFC library or repository 710. In another example implementation, a model may also be loaded (e.g., from the WFC library or repository 710) and used as a reference. This model may be composed of a signal and/or a bandwidth, as described in connection with FIG. 6. In some example implementations, if the bandwidth is loaded, a WFC may be tested to see if any point moves out of this bandwidth to determine whether it is a non-extraneous WFC.

At block 715, it is determined whether the WFCs received and/or selected at block 705 were captured using same or similar WFC characteristics. The WFC characteristics analyzed may include, for example, at least one of: sample rate, resampling algorithms, downsampling algorithms, and other waveform capture constraints. If it is determined the WFCs received and/or selected at block 705 were captured using same or similar WFC characteristics, the method may proceed to block 735. Alternatively, if it is determined the WFCs received and/or selected at block 705 were captured using same or similar WFC characteristics, the method may proceed to block 720.

At block 720, the different WFC characteristics (e.g., sample rate, etc., as noted above) are identified. The nominal sample rate, for example, may be automatically derived from WFC data, provided in waveform capture files, taken from the configuration information, or manually entered.

At block 725, it is determined whether any of the WFCs need to be reconstructed (e.g., resampled, upsampled, downsampled, decimated, etc.), for example, based on or in response to the differences identified at block 720. For example, because WFCs may be generated using dissimilar sample rates, the WFCs may need to be reconstructed to make the WFCs suitable for comparisons, meaningful analysis, etc. If it is determined one or more of the WFCs need to be reconstructed, the method may proceed to block 730. Alternatively, if it is determined none of the WFC need to be reconstructed, the method may proceed to block 735.

At block 730, the WFCs identified at block 725 as needing to be reconstructed for comparisons, meaningful analysis, etc., are reconstructed using one or more techniques (e.g., resampling, upsampling, downsampling, decimating, etc.). These techniques are common techniques that should be understood by someone with ordinary skill in the art. For example, resampling may be defined as any technique or instance of generating a new sample from an existing dataset. Definitions for the other listed techniques can be readily found and understood by one of ordinary skill in the art.

At block 735, subsequent to block 730 and/or block 715, the WFCs are compared, for example, to determine at block 740 whether a first WFC or at least one other WFC meets the criteria of being considered an extraneous WFC, a partially extraneous WFC, a redundant WFC, or a provisional WFC. For example, in one implementation, a point-by-point comparison may be performed between: at least one data point in at least one cycle of a first WFC, and at least one corresponding (i.e., occurring at the same point on the cycle) data point from at least one other WFC, at block 735 to make the determination at block 740.

For example, in one implementation, a first data point used for a comparison from the first WFC may be acquired/measured by an IED. A second data point used to compare with the first acquired/measured data point may be derived by interpolating between two acquired/measured data points from any other one or more WFCs. In this case, the first data point to be compared is empirically determined and the second data point it is compared to is derived. Conversely, the first data point to be compared may be derived and the second data point it is compared to may be empirically determined. Alternatively, both may be derived OR both may be empirical. The general purpose is to ensure the two data points to be compared from the first and second WFCs are correctly positioned based on their occurrence within the signal. In accordance with some embodiments of this disclosure, the WFCs may be required to have the same nominal frequency. If the WFCs do not have the same nominal frequency, they should generally not be compared against each other because they can never line up in time. In some example implementations, the system may be able to identify these differences and provide recommendations for addressing the differences (e.g., reconstructing the WFCs or determining the WFCs are not suitable for comparison). At a minimum, the system needs to be identifying these differences and may have settings/parameters telling what to do in these cases.

In another example implementation, the first WFC and the second WFC may be normalized to each other before the comparison is performed. For example, the RMS or peak information from the first WFC and the second WFC may be initially established. If the second WFC is being compared to the first WFC, the second WFC may be uniformly altered in magnitude, phase angle, or both and subsequently analyzed to determine whether the second WFC is at least one of extraneous, redundant and provisional. This approach will help account for changes in system voltages from the source or in slight frequency deviations from the nominal frequency.

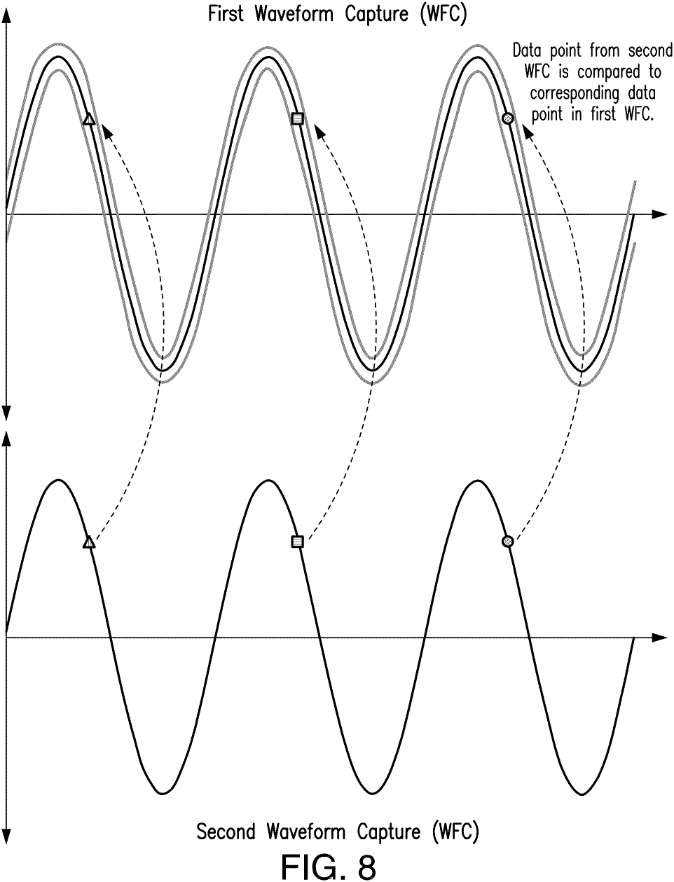

In accordance with some embodiments of this disclosure, an “ideal” WFC may also be created and used as a baseline for the first WFC. For example, a pure 120-volt, 60 Hertz signal starting at 0° with a positive polarity at a zero-crossing may be generated as an ideal WFC. This ideal WFC may then be indicated as the first WFC and used for comparison against subsequent WFCs, for example. The tolerance envelope (e.g., as discussed above in connection with FIG. 6 and described further below in connection with FIG. 8) may be applied to the first (ideal) WFC to allow some discrepancies when comparing a second WFC with the first (ideal) WFC.

Another approach, which is referred to as a frequency domain comparison approach in accordance with embodiments of this disclosure, may be to decompose the first WFC and the second WFC (to be compared with the first WFC) into their constituent/discrete frequencies (i.e., using Fourier analysis or other signal processing approaches, etc.). Once the first WFC and second WFC are decomposed, a comparison similar to those discussed above and below may be performed to determine similarities and discrepancies of the first WFC and second WFC based individually (or a combination) of one or more constituent/discrete frequency components. Thresholds may be used independently for each constituent/discrete frequency when comparing and determining whether a second WFC is extraneous, redundant or provisional.

In accordance with some embodiments of this disclosure, sensitivity of this algorithm can be configured and/or determined based on the data points and/or cycles being compared, the number of data points and/or cycles used in the comparison (averaging of multiple corresponding data points), comparison tolerance of the date points and/or cycle phase angles, comparison tolerance of the data point and/or cycle magnitude, number of consecutive data points being compared, specific phases being compared (e.g., “A,” “B,” “C,” or “1,” “2,” “3”), specific discrete harmonic components being compared (e.g., 1^{st}, 3^{rd}, 5^{th}, etc.), and so forth. In accordance with some embodiments of this disclosure, sensitivity of this algorithm can be configured and/or determined based on customer segments, load types, and any other relevant WFC files grouping or classification.

FIG. 8 is a simple illustration used to describe how this feature works. The solid black sine wave shown in the illustration is one phase of a first WFC (e.g., current, voltage). The two gray lines shown in the same illustration are a “tolerance or threshold envelope” around the first WFC to indicate a partition for determining whether a second WFC matches/corresponds/correlates with a first WFC. If a data point exceeds (above, below or outside of) the threshold envelope, the second WFC (being compared) may be considered to be different from the first WFC. If the data points from the second WFC remain within the threshold envelope of the first WFC for the part or all of the first WFC duration (or mostly within the envelope for the WFC’s length), the second WFC may be considered to be extraneous. It should be noted that additional analysis may need to be performed to determine whether the second WFC is redundant based on the discussions and definitions above. For example, in one implementation at least two WFCs may be required to be extraneous with respect to a first WFC for consideration as a redundant WFC.

The circle on the right side of the first (top) WFC (i.e., dashed arrow pointing at it) illustrates a first data point to be analyzed/evaluated. The circle on the right side of the second (bottom) WFC (i.e., dashed arrow originating from it) illustrates a corresponding second data point to be compared with the first data point. Because the first and second data points originate from different cycles and/or different WFCs, they may not be precisely the same magnitude; however, the threshold envelope encompassing the first WFC provides a tolerance for the comparison. One or more comparisons may be performed across one or more cycles of the first WFC and second WFC to determine a degree of similarity between the two WFCs. Increasing/extending or decreasing/constricting the spacing (i.e., tolerance) of the envelope will regulate the determination of successful comparisons and shifting the phase angle of the threshold envelope may affect the determination of successful comparisons. The number of points compared per cycle may also determine the success of a comparison.

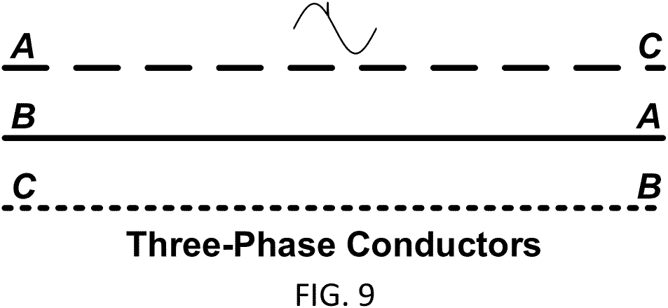

In typically installed EPMSs, phase nomenclature (i.e., labeling) issues can occur or be present. For example, FIG. 9 illustrates three conductors labeled as “A,” “B,” and “C,” respectively on the left side, and “C,” “A,” and “B,” respectively on the right side. This “mislabeling” of conductors (i.e., nomenclature discrepancy) can lead to confusion by end-users/operators when examining/evaluating or analyzing data from each respective conductor. In this case, an event determined to occur on the conductor labeled as “A” on the left side occurs on the conductor labeled as “C” on the right side. Because the mislabeling of conductors may not be recognized, the analysis to compare a first WFC and a second WFC may be misapplied. To resolve this issue, the analysis to comparison of a first WFC and a second WFC may be performed on one or more combinations of available phase conductors (i.e., A compared to “A,” “B” and “C,” etc.). Moreover, if a consistently correlative relationship between any two phases (e.g., “A” and “C”, etc.) is established indicating a mislabeling issue (i.e., a nomenclature discrepancy), the end-user/operator may be informed accordingly.

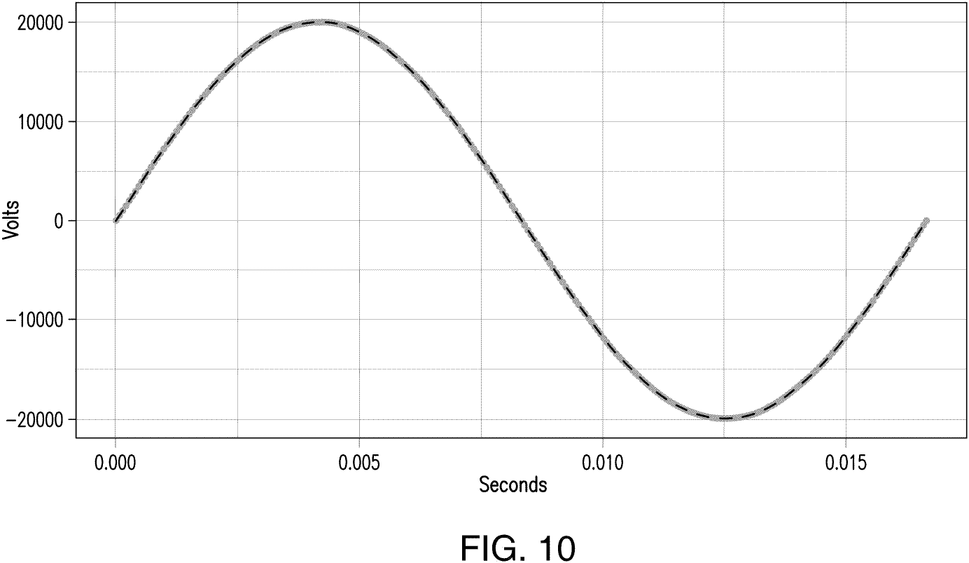

Another approach to compare a first WFC with any other one or more WFCs to identify extraneous, redundant and/or provisional WFCs is statistically-based. For example, one technique is to evaluate a residual signal difference between the first WFC and any other one or more WFCs. As mentioned above, it is possible to create and leverage an ideal signal to use as the first WFC for comparison with any other one or more WFCs. The ideal signal can be inferred from another WFC or created using nominal system parameters (e.g., frequency is 60 Hz, signal peak voltage is 20 kV, phase shift between phases is 120°, Phase A begins at 0°, the phases have a positive sequence rotation, etc.). A single-phase example is provided in FIG. 10.

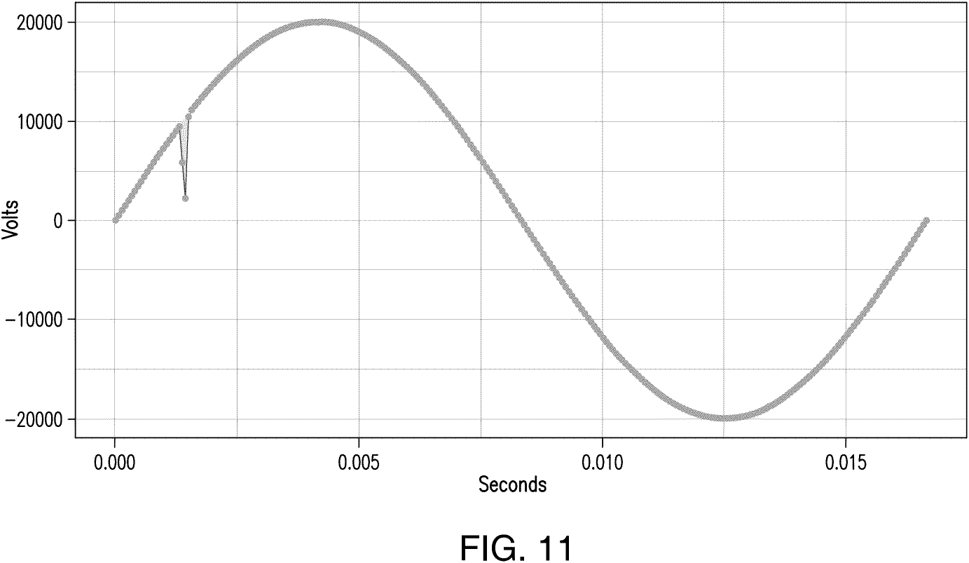

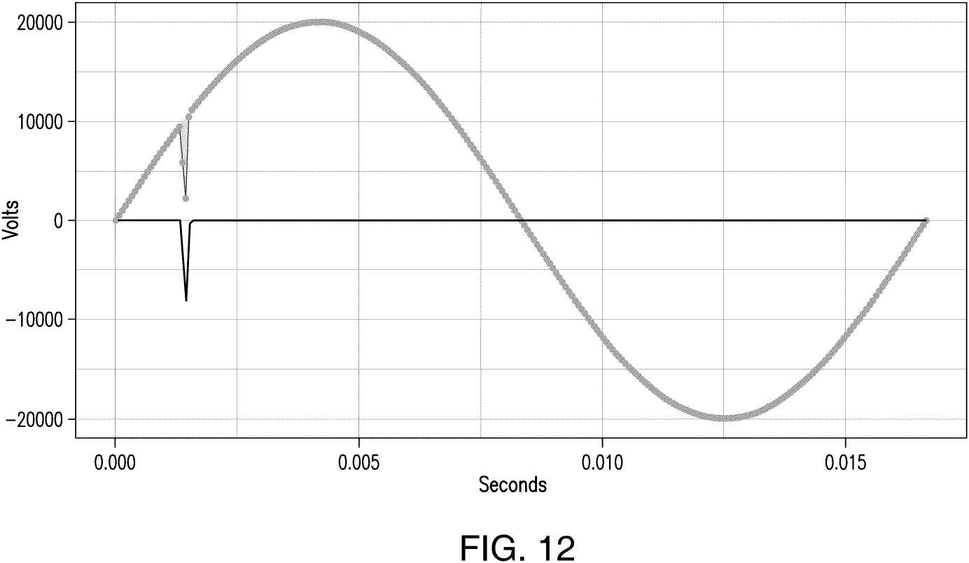

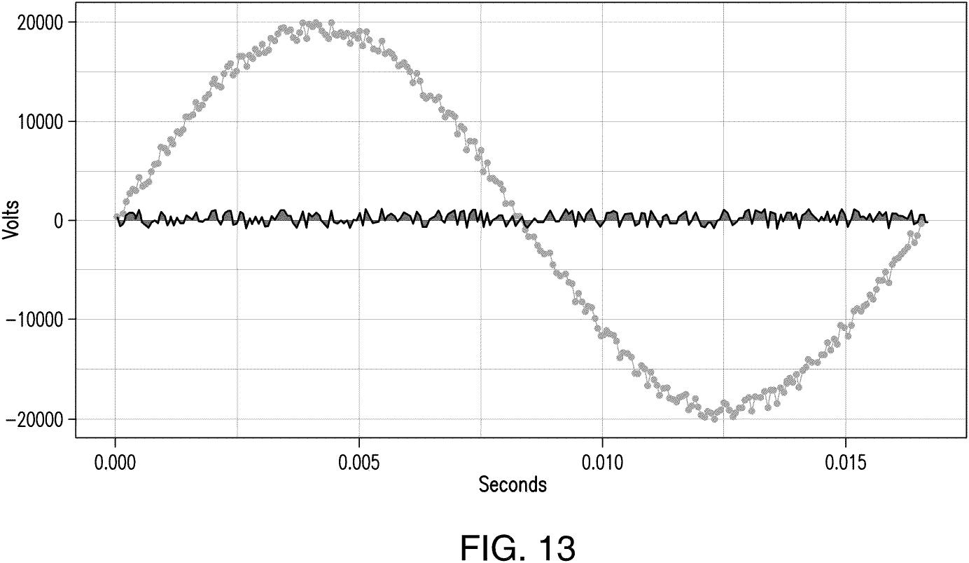

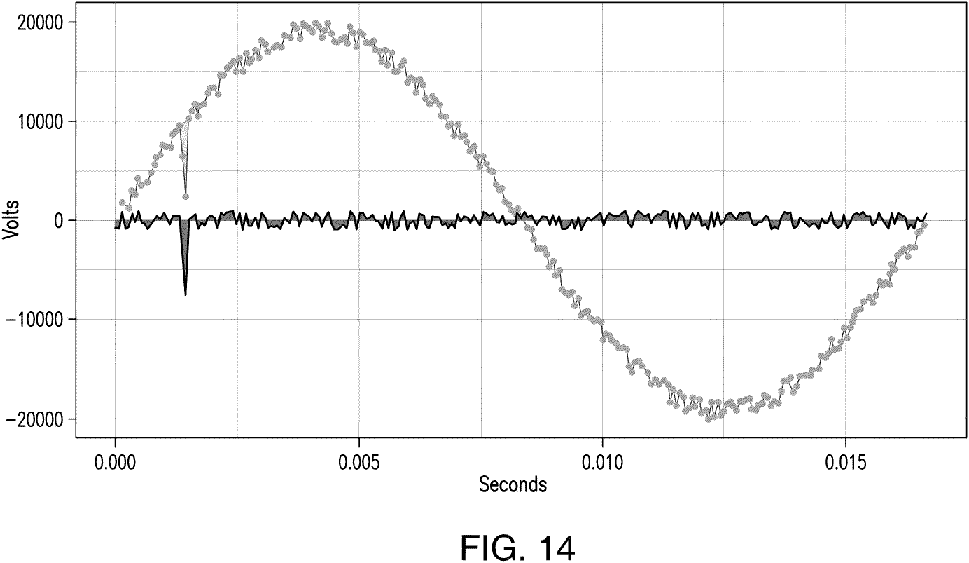

It is relatively straightforward to automatically derive a residual curve from a first (ideally created) WFC and a second WFC. For example, FIG. 12 illustrates the residual (i.e., remaining voltage) voltage (dark black line) when a notching event (shown in FIG. 11) is subtracted from the first (ideally created) WFC shown in FIG. 10. In another example, no clear event may be visible causing the residual voltage to display any noise present (FIG. 13). In one example implementation, the residual may come from subtracting the noisy signal in FIG. 13 from the ideal WFC in FIG. 10. FIG. 14 is just like FIG. 13, but also has the notching event from FIG. 12 included as well.

To help identify extraneous waveforms, a global method may simply consist of determining the residual signal between a first (ideally created) WFC and any other one or more WFCs. The mean or median of the residual signal (e.g., a distance measurement of average or median of the absolute of the residual signal) may be used to provide an indication of an extraneous, redundant or provisional WFC, which provides a good indication similarity or dissimilarity between signals. This approach may be used on partial WFCs (e.g., calculated and applied cycle-by-cycle) to determine elements of a WFC that are partially extraneous.

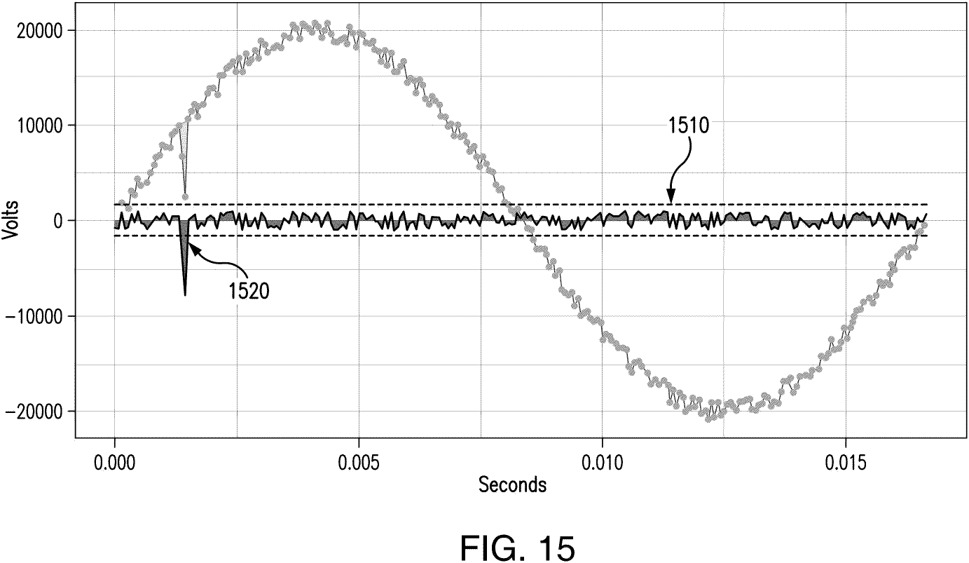

Another comparison technique may be to determine and evaluate the variance of one or more WFCs. The invention may calculate typical statistics (e.g., standard deviation from mean value, interquartile distance between first and third quartile, so between the 25^{th} percentile and the 75^{th} percentile which may be added and subtracted from the 1^{st} quartile and added to the 3^{rd} quartile, and this interquartile distance may be multiplied by 1.5 to determine any outlier, or by 3 to determine any extreme outlier), as shown in FIG. 15. This approach can be used to remove embedded noise from a signal (or WFC), facilitating a more straightforward evaluation between a first WFC and a second WFC. The invention may evaluate data points with higher SNRs (signal-to-noise ratios) that exceed the noise floor. For example, the noise floor for the signal is shown (i.e., ‘1510’) in FIG. 15, and ‘1520’ illustrates a data point exceeding the noise floor threshold. As should be apparent, the examples provided herein are not limitative, but are provided only to illustrate some of the many different possible applications and approaches of this invention.

Producing and updating at least one library that includes comparisons and results of any second WFCs to at least one of a first WFC and a first ideal WFC provides many uses. For example, analyzing library data may provide insights into causes of extraneous, redundant and provisional WFCs. This may lead to improvements in the configuration of EPMS elements, for example, threshold settings. Analyzing library data may help to better understand and reduce the quantity of provisional WFCs, potentially decreasing data processing, memory requirements, and troubleshooting complications.

As should be evident to those skilled in the domain, the residual technique should be applicable when comparing a first WFC to any second WFC. If the system compares several second WFCs to the first WFC, the system may try to score each of the secondary WFCs to select the closest approximation. In this case, the residual calculation may also provide a score. For example, using a mean residual value or a median residual value or an interquartile residual value, the system may calculate a pairwise score for each of the secondary WFCs. The system may compare these scores to determine the best match of any supplemental WFCs to the library of WFCs. The library may also store the bandwidth (aka “tolerance or threshold envelope”) as generic models to be used to determine any redundant, extraneous, partially extraneous or provisional WFC.

Another application may be to discriminate between extreme outlier points which could be indicative of errors of measurements. For example, a single point in a WFC having 1000x the max magnitude of other points (e.g., while the rest of the waveform has a very small residual) may be indicative of a probable measurement error. Such a WFC would likely be tagged as a provisional WFC.

It is understood that other techniques of distance measurement may be applied partially or over the entire WFC being compared, and all. To provide a few exemplary techniques, correlations, covariance, dynamic time warping algorithm, etc. could be used to compare WFC with other WFCs or any ideal waveform.

In another example implementation, residual signals may be phase shifted earlier or later in the WFC and/or the magnitude be increased or decreased as required. In one example implementation, the residual signal may be shifted by up to one cycle. This is useful for comparing similar WFCs, for example, where an event appears at different times within the cycle (e.g., on the positive polarity, at maximum, negative polarity, at minimum, at a specific phase angle, etc.) If the analysis allows for a time shift, then redundant WFCs will be identified based on the residual, even if the event appears at different times within the electrical cycle. For illustration purposes, it should be evident to one of ordinary skill in the art that the transient shown in FIG. 14 may occur any place within the waveform or there may be multiple events within the same WFC. For example, if a WFC (e.g., a first WFC) has a transient in the first 180° of a cycle and the WFC that it is being compared to (e.g., a second WFC) has exactly the same transient (magnitude & duration) in the 2^{nd} part of the cycle, both of these would create a 2x the transient as the difference between the two WFCs (e.g., between the first and second WFCs). If time shifted so that the transients start to overlap, then the one WFC would be considered equivalent/redundant.

Another example implementation of the disclosed invention may leverage end-user feedback to compare and/or to classify any new WFCs, for example, into an extraneous WFC, a partially extraneous WFC and/or a provisional WFC. The system may allow end-users and/or experts to visualize any new WFCs, previously captured WFCs, previously analyzed WFCs, and/or developed ideal WFCs. By optionally integrating any of the discussed comparison techniques into the visualization, the invention may emphasize differences in the compared signals or as separate signal or indicator (e.g., generated residual signal). The user may then tag any WFC as an extraneous WFC, a partially extraneous WFC, a redundant WFC, or a provisional WFC as relevant. This function could then be used to enrich the library accordingly. The invention may use the library to infer models, patterns, and characteristics based on any technique. For example, leveraging residual signal with any state-of-the-art classification and pattern inference (including neural networks and machine learning) to automatically propose a WFC classification for any WFC.

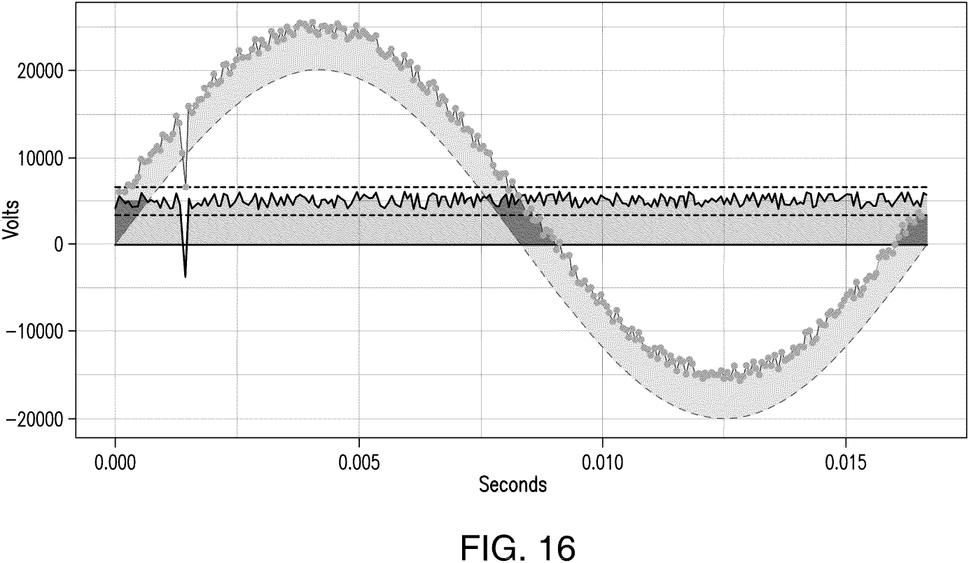

In another example implementation of the disclosed invention, the systems and/or methods disclosed herein may propose a list of best matching WFCs to a user for manual analysis and selection as a non-extraneous WFC, an extraneous WFC, a partially extraneous WFC, a provisional WFC, a redundant WFC, etc. This may seem surprising for someone not of ordinary skill in the art, but for any expert, many waveforms cumulate, include or reflect different issues. One such simplified example is visible in FIG. 16, which WFC is created as Sin() with three “issues”. In particular, in this example WFC, a transient is present in addition to noise as a DC offset (in this example, this adds +5000V to every measured point of the WFC).

In another example implementation of the disclosed invention, the systems and/or methods disclosed herein may use information associated with a WFC (e.g., event type, characteristics, time of occurrence, location of IED, type of IED, etc.) to help compare a first WFC with any other one or more WFCs. For example, if the first WFC is a voltage sag (or associated with a voltage sag event), the invention may emphasize analyses of other WFCs related to voltage sag events or with similar WFC triggering characteristics.

It is understood that the disclosed invention may perform WFC comparisons (e.g., at block 735 of method 700) in real-time or after-the-fact, singularly or as a batch, once or multiple times, partially or completely, and/or any combination thereof.

Subsequent to blocks 735 and 740 of method 700 in which the WFC comparison(s) are performed, and it is determined whether the WFCs are considered extraneous WFCs or include at least one extraneous WFC (or if the WFCs may be characterized in another manner), the method may end in some embodiments. In other embodiments, the method may return to block 705 and repeat again (e.g., for analyzing new WFCs). In some embodiments in which the method ends after block 740, the method may be initiated again in response to user input, automatically, and/or a control signal, for example.

It is understood that method 700 may include one or more additional blocks or steps in some embodiments, as will be apparent to one of ordinary skill in the art. It is also understood that in embodiments in which the method 700 is performed in conjunction with methods 400 and/or 500 discussed above, for example, subsequent to method 700 completing, information from the steps performed in method 700 may be used in methods 400 and/or 500. For example, subsequent to block 740 of method 700, the steps illustrated by blocks 415 and/or 420 of method 400 may be performed based on or in response to the information from block 735 and/or other blocks of method 700. Additionally, in accordance with some embodiments of this disclosure, one or more of the WFCs evaluated using method 700 may also be evaluated using method 500 to determine if the WFCs are partially extraneous WFCs. For example, a WFC that is determined to not being extraneous in method 700 may be further evaluated using method 500 to determine if the WFC is partially extraneous.

As will be appreciated by one of ordinary skill in the art, the systems and methods disclosed herein facilitate analysis of WFCs and help remove the “noise” from the useful/pertinent data (e.g., WFCs), simplifying event analysis for end-users. As such it may create a library of the different reference (or first) WFCs. Additionally, the disclosed systems and methods minimize the memory and processing requirements of products (H/W, S/W, Cloud, Gateways).

The disclosed systems and methods also facilitate better Artificial Intelligence (AI) and Machine Learning (ML) capabilities by removing superfluous data that can lead to data bias (while still quantifying and trending the occurrences and keeping the link to the reference WFC). For example, the WFCs and associated data identified as extraneous can be used to build data sets to help train ML, AI, Analytics applications to better identify at least one of extraneous WFCs and associated data. Typically, neural networks and other Deep Learning or ML algorithms are often very sensitive to over-fitting. For example, over-fitting could appear when only WFC with a very “clean” signal were used to train the model. To avoid such an over-fitting, adding all the different extraneous WFC would create a more robust deep learning model. By injecting all the reference waveforms with their discrete analysis (e.g., all the different WFC categorized as “voltage sag”) would further create a more robust and generalized inferred deep learning model. All the different noise levels (e.g., a WFC with a stronger noise level than the WFC in FIG. 10 is illustrated in FIG. 13) will be well understood to any one of ordinary skill in the art. By adding previously tagged WFCs (e.g., as extraneous, as provisional, as non-extraneous, as redundant or as non-redundant) into the library, a deep learning model may be inferred and then used to classify any new WFC as extraneous, partially extraneous or provisional. This should be evident to one of ordinary skill in the art of data science deep learning.

In accordance with some embodiments of this disclosure, the systems and methods described herein may be used to overtly illustrate a company’s (e.g., Schneider Electric’s) expertise in energy-related analyses and energy-related systems.

It is understood that there are many possible extensions relating to the above discussed invention relating to automatically identifying, analyzing and reducing extraneous WFCs. For example, listed below are some example possible extensions.
In accordance with some embodiments of this disclosure, it is possible to create an ontology of WFCs which will be used for classifying a WFC as being (or not) extraneous, partially extraneous, provisional, redundant, or none of these.
   ○ For example, the ontology may add an impact dimension to the WFC library. WFC may have different impact depending on the customer segment or installation size, load types being monitored by the IED, etc.
   ○ Another example would be enriching the Power Quality issue (e.g., a voltage sag or a voltage swell for example) with the dimension of the type of device and the type and age of the CT (current transformer) as this may influence the WFC.
Using a customer or segment type to improve and/or determine standards/thresholds/constraints/limitations for identifying extraneous WFCs (and associated data).
   ○ The customer or segment type may also be used to determine how extraneous WFCs are managed (e.g., deleted, compressed, merely tagged, etc.)
The reason for originally capturing a WFC may be considered to help identify and manage superfluous/extraneous WFCs (i.e., the original trigger of a WFC is relevant to determining if it should be deemed/considered an extraneous WFC). For example, a WFC intentionally captured at a peak load, min load, typical load, after a process starts, etc. may appear to be an extraneous WFC after a cursory analysis; however, there are reasons to have these WFCs for future analysis. Metadata tags to WFCs (or other indicators) may be used to indicate a given WFC should not be deemed/considered an extraneous WFC. These same WFCs may (in fact) be deemed/considered as useful and “normal,” but with “no event present,” and categorized/tagged/indicated as such.

Additional extensions relating to the above discussed invention will be apparent to one of ordinary skill in the art.

As described above and as will be appreciated by those of ordinary skill in the art, embodiments of the disclosure herein may be configured as a system, method, or combination thereof. Accordingly, embodiments of the present disclosure may be comprised of various means including hardware, software, firmware or any combination thereof.

It is to be appreciated that the concepts, systems, circuits, calculations, algorithms, processes, procedures and techniques sought to be protected herein are not limited to use in the example applications described herein (e.g., power monitoring system applications), but rather may be useful in substantially any application where it is desired to reduce extraneous WFCs. While particular embodiments and applications of the present disclosure have been illustrated and described, it is to be understood that embodiments of the disclosure not limited to the precise construction and compositions disclosed herein and that various modifications, changes, and variations can be apparent from the foregoing descriptions without departing from the spirit and scope of the disclosure as defined in the appended claims.

Having described preferred embodiments, which serve to illustrate various concepts, structures and techniques that are the subject of this patent, it will now become apparent to those of ordinary skill in the art that other embodiments incorporating these concepts, structures and techniques may be used. Additionally, elements of different embodiments described herein may be combined to form other embodiments not specifically set forth above.

Accordingly, it is submitted that that scope of the patent should not be limited to the described embodiments but rather should be limited only by the spirit and scope of the following claims.

What is claimed is:

1. A method for automatically identifying, analyzing and reducing extraneous waveform captures (WFCs), comprising:
capturing at least one energy-related waveform in an electrical system using at least one waveform capture device;
analyzing the at least one captured energy-related waveform to determine whether the at least one captured energy-related waveform meets the criteria of being considered an extraneous WFC, a partially extraneous WFC, a redundant WFC, or a provisional WFC; and
performing one or more actions in response to determining the at least one captured energy-related waveform meets the criteria of being considered an extraneous WFC, a partially extraneous WFC, a redundant WFC, or a provisional WFC.

2. The method of claim 1, wherein the one or more actions that are performed in response to determining the at least one captured energy-related waveform meets the criteria of being considered an extraneous WFC, a partially extraneous WFC, a redundant WFC, or a provisional WFC, include at least one of: deleting or otherwise removing the at least one captured energy-related waveform, tagging or otherwise indicating the defined status of the at least one captured energy-related waveform, storing the at least one captured energy-related waveform in specific location(s), recommending and/or updating waveform capture setting(s) and/or configuration(s) in the at least one waveform capture device capturing the at least one captured energy-related waveform, lowering and/or reducing the priority and/or importance of the at least one captured energy-related waveform, compressing the at least one captured energy-related waveform, and reducing the at least one captured energy-related waveform by one or more cycles to minimize its memory requirements.

3. The method of claim 1, further comprising:
taking one or more additional actions subsequent to and/or in parallel to performing the at least one of the actions in response to determining the at least one captured energy-related waveform meets the criteria of being deemed/considered an extraneous WFC, a partially extraneous WFC, a redundant WFC, or a provisional WFC, the one or more additional actions including at least one of: extracting associated alarm data, using data and/or information associated with the at least one captured energy-related waveform for other purposes such as a sample of the electrical system’s post-event response, changing other settings in association with alarm settings for more efficient alarms and alarm prioritization, and using data and/or information associated with the at least one captured energy-related waveform to enhance segment-related analytics in cloud-based applications and/or to simplify what is presented to users in reports or on displays.

4. The method of claim 1, wherein a point-by-point comparison is performed between: at least one data point in at least one first cycle of the at least one captured energy-related waveform, and at least one or more corresponding data points in at least one second cycle of the at least one captured energy-related waveform and/or other WFCs, to determine whether the at least one captured energy-related waveform meets the criteria of being considered an extraneous WFC, a partially extraneous WFC, a redundant WFC, or a provisional WFC.

5. The method of claim 4, wherein at least one of: the at least one data point in the at least one first cycle of the at least one captured energy-related waveform, and the at least one or more corresponding data points in the at least one second cycle of the at least one captured energy-related waveform and/or other WFCs, is at least one of empirically determined and derived by interpolating to ensure the data points are correctly positioned based on their occurrence within the at least one captured energy-related waveform.

6. The method of claim 4, wherein sensitivity of the algorithm used to perform the point-by-point comparison can be configured and/or determined based on at least one of: the data points and/or cycles being compared, the number of data points and/or cycles used in the comparison, comparison tolerance of the date points and/or cycle phase angles, comparison tolerance of the data point and/or cycle magnitude, number of consecutive data points being compared, and specific phases being compared.

7. The method of claim 1, wherein the at least one captured energy-related waveform is compared to at least one other WFC to determine whether the at least one captured energy-related waveform meets the criteria of being considered an extraneous WFC, a partially extraneous WFC, a redundant WFC, or a provisional WFC.

8. The method of claim 7, wherein the at least one other WFC is or includes at least one WFC and/or at least one model of a WFC from a WFC library or repository.

9. The method of claim 8, wherein the WFC library or repository is a cloud-based WFC library or repository.

10. The method of claim 7, wherein the at least one captured energy-related waveform is compared to at least one other WFC using one or more data analysis techniques, the one or more data analysis techniques including at least one of: expert-based algorithms, rules-based algorithms, statistics-based algorithms, visual comparison(s), curve fitting algorithms, signal processing algorithms, and unsupervised, semi-supervised and supervised learning techniques and algorithms.

11. The method of claim 1, wherein in response to determining the at least one captured energy-related waveform meets the criteria of being considered a partially extraneous WFC, the at least one captured energy-related waveform is reduced by one or more data points to simplify future analysis of the at least one captured energy-related waveform and/or for minimizing memory requirements for storing the at least one captured energy-related waveform.

12. The method of claim 1, further comprising:
in response to determining the at least one captured energy-related waveform does not meet the criteria of being considered an extraneous WFC, a partially extraneous WFC, a redundant WFC, or a provisional WFC, determining whether the at least one captured energy-related waveform meets the criteria of being considered a redundant WFC or another WFC classification.

13. The method of claim 1, further comprising:
determining whether each WFC of the at least one captured waveform to be analyzed was captured using same or similar WFC characteristics; and
in response to determining each WFC of the at least one captured waveform to be analyzed was not captured using same or similar WFC characteristics, determining
whether one or more of the WFCs need to be reconstructed to make the WFCs suitable for comparisons and/or other meaningful analysis.

14. The method of claim 13, wherein the WFC characteristics include at least one of: sample rate, resampling algorithms, downsampling algorithms, and other waveform capture constraints.

15. The method of claim 13, wherein in response to determining one or more of the WFCs need to be reconstructed to make the WFCs suitable for comparisons and/or other meaningful analysis, the one or more of the WFCs are reconstructed based on or using one or more techniques.

16. The method of claim 15, wherein the one or more techniques include at least one of: resampling, upsampling, downsampling, decimating, normalizing, and adding a range of acceptability.

17. The method of claim 1, wherein the criteria of being considered an extraneous WFC, a partially extraneous WFC, a redundant WFC, or a provisional WFC is/are based, at least in part, on at least one of: load type(s), load mix, process(es), application(s) and customer type(s).

18. The method of claim 1, wherein the at least one waveform capture device includes at least one Intelligent Electronic Device (IED).

19. The method of claim 1, wherein the at least one waveform capture device is associated with an Electrical Power Monitor System (EPMS) responsible for monitoring and/or controlling one or more aspects of the electrical system.

20. A system for automatically identifying, analyzing and reducing extraneous waveform captures (WFCs), comprising:
at least one processor;
at least one memory device coupled to the at least one processor, the at least one processor and the at least one memory device configured to:
capture at least one energy-related waveform in an electrical system using at least one waveform capture device;
analyze the at least one captured energy-related waveform to determine whether the at least one captured energy-related waveform meets the criteria of being considered an extraneous WFC, a partially extraneous WFC, a redundant WFC, or a provisional WFC; and
perform one or more actions in response to determining the at least one captured energy-related waveform meets the criteria of being considered an extraneous WFC, a partially extraneous WFC, a redundant WFC, or a provisional WFC.

21. The system of claim 20, wherein the system is or includes one or more components of an Electrical Power Monitoring System (EPMS).

22. The system of claim 21, wherein the EPMS is responsible for monitoring electrical signals, data derived from electrical signals, and/or controlling one or more aspects of the electrical system.
